(19) United States
(12) Patent Application Publication
(10) Pub. No.: US 2010/0321363 A1
(43) Pub. Date: Dec. 23, 2010

(54) PLASMA DISPLAY PANEL DRIVING DEVICE AND PLASMA DISPLAY

(75) Inventors: Tatsuo Morita, Kyoto (JP); Manabu Yanagihara, Osaka (JP); Hidetoshi Ishida, Osaka (JP); Yasuhiro Uemoto, Shiga (JP); Manabu Inoue, Kyoto (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/518,005

(22) PCT Filed: Jun. 19, 2008
(86) PCT No.: PCT/JP2008/001588

§ 371 Date: Jun. 5, 2009

(30) Foreign Application Priority Data
Jun. 22, 2007 (JP) 2007-165526

(51) Int. Cl. G09G 3/28

(52) U.S. Cl. 345/211; 345/60

(57) ABSTRACT

A plasma display panel driving device includes an electrode driving unit for generating a drive pulse to be applied to an electrode of a plasma display panel. The electrode driving unit has a plurality of switches. At least one of the plurality of switches is a switch device including a dual-gate semiconductor device. The dual-gate semiconductor device 10 has a semiconductor multilayer 13 formed on a substrate 11 and made of a nitride semiconductor or a silicon carbide semiconductor, a source electrode 16 and a drain electrode 17 formed and spaced apart from each other on the semiconductor multilayer 13, and a first gate electrode 18A and a second gate electrode 18B formed between the source electrode 16 and the drain electrode 17, successively from the source electrode 16 side.

### TECHNICAL FIELD

The present invention relates to a plasma display panel driving device and a plasma display.

### BACKGROUND ART

A plasma display is a display device that utilizes a light emission phenomenon caused by gaseous electric discharge. Plasma displays have a display portion, i.e., a plasma display panel (PDP), which has advantages over other display devices in terms of larger size, smaller thickness and broader viewing angle. PDPs are broadly divided into a DC type that is operated with direct-current pulses and an AC type that is operated with alternating-current pulses. AC-type PDPs particularly have high luminance and a simple structure. Therefore, AC-type PDPs are suitable for mass-production and high pixel density, and are widely used.

For example, an AC-type PDP has a three-electrode surface discharge structure (see, for example, Patent Document 1). In the structure, address electrodes are arranged in the vertical direction of the panel on the rear substrate of the PDP, and sustain electrodes and scan electrodes are alternately arranged in the horizontal direction of the panel on the front substrate of the PDP. The potentials of the address electrodes and the scan electrodes are generally changed one by one.

Discharge cells are provided at intersections of pairs of a sustain electrode and a scan electrode adjacent to each other and address electrodes. On a surface of each discharge cell, a layer made of a dielectric material (dielectric material layer), a layer for protecting the electrodes and the dielectric material layer (protective layer), and a layer containing a fluorescent substance (fluorescent layer) are provided. Gas is enclosed inside the discharge cell. When a pulse voltage is applied between the sustain electrode, the scan electrode and the address electrode to generate discharge in the discharge cell, gas molecules in the discharge cell are ionized, emitting ultraviolet light. The ultraviolet light then excites the fluorescent substance on the discharge cell surface, thereby generating fluorescence. Thus, the discharge cell emits light.

A PDP driving device generally controls the potentials of the sustain electrodes, the scan electrodes and the address electrodes of the PDP in accordance with the Address Display-period Separation (ADS) method. The ADS method is a type of sub-field method. In sub-field methods, a field of image is divided into a plurality of sub-fields. Each sub-field includes a reset period, an address period, and a discharge sustaining period. Particularly in the ADS method, all discharge cells of the PDP have the same three periods (see, for example, Patent Document 1).

During the reset period, a reset pulse voltage is applied between the sustain electrode and the scan electrode. Thereby, all the discharge cells have uniform wall charge.

During the address period, a scan pulse voltage is successively applied to the scan electrodes, and a signal pulse voltage is applied to some of the address electrodes. Here, the address electrodes to which the signal pulse voltage is to be applied are selected based on an externally input video signal. When the scan pulse voltage is applied to a scan electrode and the signal pulse voltage is applied to an address electrode, discharge occurs at a discharge cell located at the intersection of the scan electrode and the address electrode. This discharge causes wall charge to be accumulated in the surface of the discharge cell.

During the discharge sustaining period, a discharge sustaining pulse voltage is applied to all pairs of a sustain electrode and a scan electrode simultaneously and periodically. In this case, gaseous discharge is sustained in discharge cells in which wall charge has been accumulated during the address period, so that light is emitted. The length of the discharge sustaining period varies from sub-field to sub-field. Therefore, a light emission duration per field of a discharge cell, i.e., the luminance of the discharge cell, is adjusted by selecting a sub-field.

FIG. 27 shows a configuration of a conventional PDP driving device. FIG. 27 particularly shows a scan electrode driving unit and a PDP. The scan electrode driving unit 110 includes a scan pulse generating unit 111, a reset pulse generating unit 112, and a discharge sustaining pulse generating unit 113. The discharge sustaining pulse generating unit 113 includes a high-side sustain switch Q7Y and a low-side sustain switch Q8Y, which are connected in series, and controls a voltage between a sustain electrode X and a scan electrode Y using a sustain voltage source Vs or a ground potential via the high-side sustain switch Q7Y and the low-side sustain switch Q8Y. The PDP 120 is represented by an equivalent capacitance Cp (hereinafter referred to as a “panel capacitance of a PDP”) between a sustain electrode X and a scan electrode Y, and a path through which a current flows through the PDP 120 during discharge in a discharge cell is not shown. In FIG. 27, a sustain electrode driving unit connected to the sustain electrode X is not shown, and the sustain electrode X is grounded.

The upper limit of the reset pulse voltage needs to be sufficiently high to provide uniform wall charge in all discharge cells in a PDP during the reset period. Also, the lower limit of the scan pulse voltage needs to be sufficiently low to generate address discharge during the address period. Therefore, the upper limit of the reset pulse voltage is typically set to be higher than the upper limit of the discharge sustaining pulse voltage. Also, the lower limit of the scan pulse voltage is typically set to be lower than the lower limit of the discharge sustaining pulse voltage. Therefore, in order to prevent the reset pulse voltage from being clamped at the upper limit of the discharge sustaining pulse voltage, the sustain voltage source Vs of the discharge sustaining pulse generating unit 113 needs to be separated from the reset pulse generating unit 112 during the reset period. Therefore, in order to prevent the scan pulse voltage from being clamped at the lower limit of the discharge sustaining pulse voltage, the sustain voltage source Vs of the discharge sustaining pulse generating unit 113 needs to be separated from the scan pulse generating unit 111 during the address period.

In conventional PDP driving devices, a separation switch QS1 and a separation switch QS2 are provided between the sustain voltage source Vs and the reset pulse generating unit 112. In the example of FIG. 27, a high-side separation switch QS1 and a low-side separation switch QS2 are inserted.

During the discharge sustaining period, the high-side separation switch QS1 and the low-side separation switch QS2 are in the ON state, and the positive and negative potentials of the sustain voltage source Vs are supplied from an output terminal JY2 of the discharge sustaining pulse generating unit 113 by switching of the high-side sustain switch Q7Y and the low-side sustain switch Q8Y in the discharge sustaining pulse generating unit 113.

During the reset period, the high-side separation switch QS1 and the low-side separation switch QS2 are in the OFF state, and the reset pulse generating unit 112 is separated from the sustain voltage source Vs.

Thus, the reset pulse voltage increases to a predetermined upper limit and decreases to a predetermined lower limit without being clamped at the upper and lower limits of the discharge sustaining pulse voltage. Therefore, during the reset period, a voltage sufficient to achieve uniform wall charge is applied to all discharge cells in a PDP.

Moreover, in conventional PDP driving devices, during the discharge sustaining period, power in the panel capacitance Cp is recovered by a resonance circuit including a high-side recovery switch Q9Y and a low-side recovery switch Q10Y, a first recovery diode D1, a second recovery diode D2, a recovery inductor LY and an energy-recovery capacitor CY. The first recovery diode D1 and the second recovery diode D2 used here play a role in preventing a current from flowing into the energy-recovery capacitor CY when the high-side sustain switch Q7Y and the low-side sustain switch Q8Y go to the ON state, thereby holding the energy-recovery capacitor CY at a constant value (Vs/2).

### Patent Document 1: Japanese Unexamined Patent Application Publication No. 2005-70787

### DISCLOSURE OF THE INVENTION

### Problems to be Solved by the Invention

However, a current (caused by discharge in a discharge cell of a PDP) caused by application of the discharge sustaining pulse voltage flows through the high-side separation switch QS1 and the low-side separation switch QS2 during the discharge sustaining period. The amount of this current is typically larger than those of currents caused by application of other pulse voltages, so that the power consumption of the PDP driving device largely increases due to conduction losses in the high-side separation switch QS1 and the low-side separation switch QS2. In order to reduce the conduction loss of a switch device, a separation switch is known in which a large number of semiconductor devices are connected in parallel and therefore a large current is controlled using a low resistance. In this case, however, the area of the PDP driving device increases. Also, an increase in the number of parts leads to an increase in manufacturing cost.

Also, a recovery current that flows during the recovery operation is large, so that conduction losses in the first recovery diode D1 and the second recovery diode D2 also lead to a large increase in power consumption of the PDP driving device. Also in this case, a recovery diode is known in which a large number of diodes are connected in parallel and therefore a large current is provided with a low resistance. In this case, however, the area of the PDP driving device increases. Also, an increase in the number of parts leads to an increase in manufacturing cost.

Thus, in the aforementioned conventional PDP apparatuses, it is difficult to simultaneously achieve a reduction in power consumption and a reduction in device area (i.e., a reduction in the number of parts).

An object of the present invention is to provide a plasma display panel driving device having a smaller number of parts and lower power consumption, thereby solving the aforementioned conventional problems.

### Solution to the Problems

To achieve the object, the present invention provides a plasma display panel driving device comprising a switch device including a dual-gate semiconductor device.

Specifically, a plasma display panel driving device according to the present invention includes an electrode driving unit for generating a drive pulse to be applied to an electrode of a plasma display panel. The electrode driving unit has a plurality of switches. At least one of the plurality of switches is a switch device including a dual-gate semiconductor device. The dual-gate semiconductor device has a semiconductor multilayer formed on a substrate and made of a nitride semiconductor or a silicon carbide semiconductor, a source electrode and a drain electrode formed and spaced apart from each other on the semiconductor multilayer, and a first gate electrode and a second gate electrode formed between the source electrode and the drain electrode, successively from the source electrode side.

The plasma display panel driving device of the present invention employs a switch device including a dual-gate semiconductor device. Therefore, as compared to when a plurality of transistors and diodes are used to construct a switch, conduction loss in the device can be significantly reduced. Also, the area of the switch can be significantly reduced. Thereby, the power consumption of the plasma display panel driving device can be reduced, and in addition, the size thereof can be reduced.

In the plasma display panel driving device of the present invention, the electrode driving unit has a sustain voltage source for generating a voltage for sustaining discharge of the plasma display panel. The plurality of switches include a high-side sustain switch and a low-side sustain switch connected in series between a positive terminal and a negative terminal of the sustain voltage source. At least one of the high-side sustain switch and the low-side sustain switch is a switch device including the dual-gate semiconductor device.

In the plasma display panel driving device of the present invention, the electrode driving unit may have a sustain voltage source for generating a voltage for sustaining discharge of the plasma display panel. The plurality of switches may include a high-side sustain switch and a low-side sustain switch connected in series between a positive terminal and a negative terminal of the sustain voltage source, and a separation switch connected between a connection node of the high-side sustain switch and the low-side sustain switch, and the electrode of the plasma display panel. The separation switch may be a switch device including the dual-gate semiconductor device.

In the plasma display panel driving device of the present invention, the electrode driving unit may have an energy-recovery capacitor for recovering and accumulating electric charges accumulated in the electrode of the plasma display panel. The plurality of switches may include a recovery switch provided between the electrode of the plasma display panel and the energy-recovery capacitor. The recovery switch may be a switch device including the dual-gate semiconductor device.

In the plasma display panel driving device of the present invention, the electrode driving unit may have an energy-recovery capacitor for recovering and accumulating electric charges accumulated in the electrode of the plasma display panel. The plurality of switches may include a first recovery switch and a second recovery switch provided between the electrode of the plasma display panel and the energy-recovery capacitor. The first recovery switch and the second recovery switch may each be a switch device including the dual-gate semiconductor device.

In the plasma display panel driving device of the present invention, the recovery switch, when causing a current to flow from the energy-recovery capacitor to the electrode, may go to a first mode in which a current is caused to flow from the energy-recovery capacitor to the electrode and a current is blocked from flowing to the energy-recovery capacitor. The recovery switch, when causing a current to flow from the electrode to the energy-recovery capacitor, may go to a second mode in which a current is caused to flow from the electrode to the energy-recovery capacitor and a current is blocked from flowing from the energy-recovery capacitor.

In the plasma display panel driving device of the present invention, the recovery switch, when causing a current to flow from the energy-recovery capacitor to the electrode, may go to a third mode in which a voltage higher than or equal to a threshold voltage of the first gate electrode with reference to a potential of the source electrode is applied to the first gate electrode, and a voltage higher than or equal to a threshold voltage of the second gate electrode with reference to a potential of the drain electrode is applied to the second gate electrode, thereby causing a current to flow between the drain electrode and the source electrode, before going to the first mode. The recovery switch, when causing a current to flow from the electrode to the energy-recovery capacitor, may go to the third mode before going to the second mode.

In the plasma display panel driving device of the present invention, the first recovery switch, when causing a current to flow from the energy-recovery capacitor to the electrode, may go to a first mode in which a current is caused to flow from the energy-recovery capacitor to the electrode and a current is blocked from flowing to the energy-recovery capacitor. The second recovery switch, when causing a current to flow from the electrode to the energy-recovery capacitor, may go to a second mode in which a current is caused to flow from the electrode to the energy-recovery capacitor and a current is blocked from flowing from the energy-recovery capacitor.

In the plasma display panel driving device of the present invention, the first recovery switch, when causing a current to flow from the energy-recovery capacitor to the electrode, may go to a third mode in which a voltage higher than or equal to a threshold voltage of the first gate electrode with reference to a potential of the source electrode is applied to the first gate electrode, and a voltage higher than or equal to a threshold voltage of the second gate electrode with reference to a potential of the drain electrode is applied to the second gate electrode, thereby causing a current to flow between the drain electrode and the source electrode, before going to the first mode. The second recovery switch, when causing a current to flow from the electrode to the energy-recovery capacitor, may go to the third mode before going to the second mode.

In the plasma display panel driving device of the present invention, the dual-gate semiconductor device may be normally OFF.

In the plasma display panel driving device of the present invention, the semiconductor multilayer may have a first semiconductor layer, and a first p-type semiconductor layer selectively formed on the first semiconductor layer. The first gate electrode may be formed on the first p-type semiconductor layer.

In the plasma display panel driving device of the present invention, the semiconductor multilayer may have a first semiconductor layer, and a second p-type semiconductor layer selectively formed on the first semiconductor layer. The second gate electrode may be formed on the second p-type semiconductor layer.

The plasma display panel driving device of the present invention may further include an insulating film formed between at least one of the first gate electrode and the second gate electrode, and the semiconductor multilayer.

In the plasma display panel driving device of the present invention, the semiconductor multilayer may have a concave portion. At least one of the first gate electrode and second gate electrode may be embedded in the concave portion.

In the plasma display panel driving device of the present invention, the threshold voltage of the first gate electrode of the dual-gate semiconductor device may be different from the threshold voltage of the second gate electrode.

In the plasma display panel driving device of the present invention, the second gate electrode and the drain electrode of the dual-gate semiconductor device may be electrically connected.

In the plasma display panel driving device of the present invention, a space between the first gate electrode and the second gate electrode of the dual-gate semiconductor device may be larger than a space between the source electrode and the first gate electrode and is larger than a space between the drain electrode and the second gate electrode.

In the plasma display panel driving device of the present invention, the semiconductor multilayer of the dual-gate semiconductor device may have a first semiconductor layer and a second semiconductor layer successively laminated from the substrate side. The second semiconductor layer may have a band gap larger than that of the first semiconductor layer.

In the plasma display panel driving device of the present invention, the semiconductor multilayer may include at least one of gallium nitride and aluminum nitride gallium.

A plasma display according to the present invention includes a plasma display panel in which a fluorescent material emits light due to discharge between electrodes, and the plasma display panel driving device of the present invention.

### EFFECT OF THE INVENTION

According to the plasma display panel driving device and the plasma display of the present invention, it is possible to achieve a plasma display panel driving device and a plasma display in which the number of parts is small and power consumption is low.

### BRIEF DESCRIPTION OF THE DRAWINGS

FIG. 1 is a block diagram showing a configuration of a plasma display according to a first embodiment of the present invention.

FIG. 2 is a circuit diagram showing a scan electrode driving unit of a plasma display driving device according to the first embodiment of the present invention.

FIG. 3 is a timing diagram showing an operation of the scan electrode driving unit of the plasma display driving device of the first embodiment of the present invention.

FIG. 4 is a circuit diagram showing a bidirectional switch including a plurality of transistors.

FIG. 5 is a cross-sectional view showing a first dual-gate semiconductor device used in the plasma display driving device of the first embodiment of the present invention.

FIG. 6 is a circuit diagram for describing a bidirectional switch operation of a dual-gate semiconductor device used in the plasma display driving device of the first embodiment of the present invention.

FIGS. 7(a) to 7(c) are circuit diagrams for describing a reverse blocking operation of the dual-gate semiconductor device used in the plasma display driving device of the first embodiment of the present invention.

FIGS. 8(a) to 8(c) are graphs showing operation characteristics of the dual-gate semiconductor device used in the plasma display driving device of the first embodiment of the present invention.

FIG. 9 is a cross-sectional view showing a second dual-gate semiconductor device used in the plasma display driving device of the first embodiment of the present invention.

FIG. 10 is a cross-sectional view showing a third dual-gate semiconductor device used in the plasma display driving device of the first embodiment of the present invention.

FIG. 11 is a circuit diagram showing a drive unit for driving the dual-gate semiconductor device used in the plasma display driving device of the first embodiment of the present invention.

FIG. 12 is a circuit diagram showing a scan electrode driving unit in the plasma display driving device of the first embodiment of the present invention.

FIG. 13 is a timing diagram showing a first operation of the scan electrode driving unit in the plasma display driving device of the first embodiment of the present invention.

FIG. 14 is a timing diagram showing a second operation of the scan electrode driving unit in the plasma display driving device of the first embodiment of the present invention.

FIG. 15 is a circuit diagram showing a scan electrode driving unit in a plasma display driving device according to a second embodiment of the present invention.

FIG. 16 is a timing diagram showing a first operation of the scan electrode driving unit in the plasma display driving device of the second embodiment of the present invention.

FIG. 17 is a timing diagram showing a second operation of the scan electrode driving unit in the plasma display driving device of the second embodiment of the present invention.

FIG. 18 is a circuit diagram showing a scan electrode driving unit in a plasma display driving device according to a third embodiment of the present invention.

FIG. 19 is a timing diagram showing a first operation of the scan electrode driving unit in the plasma display driving device of the third embodiment of the present invention.

FIG. 20 is timing diagram showing a second operation of the scan electrode driving unit in a plasma display driving device according to a third embodiment of the present invention.

FIG. 21 is a circuit diagram showing a scan electrode driving unit in a plasma display driving device according to a fourth embodiment of the present invention.

FIG. 22 is a cross-sectional view showing a dual-gate semiconductor device used in the plasma display driving device of the fourth embodiment of the present invention.

FIG. 23 is a cross-sectional view showing a dual-gate semiconductor device used in the plasma display driving device of the fourth embodiment of the present invention.

FIG. 24 is a cross-sectional view showing a dual-gate semiconductor device used in the plasma display driving device of the fourth embodiment of the present invention.

FIG. 25 is a circuit diagram showing a variation of a discharge sustaining pulse generating circuit used in the plasma display driving device of the fourth embodiment of the present invention.

FIG. 26 is a circuit diagram showing a variation of the discharge sustaining pulse generating circuit used in the plasma display driving device of the fourth embodiment of the present invention.

FIG. 27 is a circuit diagram showing a scan electrode driving unit of a plasma display driving device according to a conventional example.

### DESCRIPTION OF THE REFERENCE CHARACTERS

10 dual-gate semiconductor device
11 substrate
12 buffer layer
13 semiconductor multilayer
14 GaN layer
15 AlGaN layer
16 source electrode
16A first ohmic electrode
16B second ohmic electrode
17 drain electrode
18A first gate electrode
18B second gate electrode
19A first p-type semiconductor layer
19B second p-type semiconductor layer
20 drive unit
23 load power supply
24 first power supply
25 second power supply
28 first gate driving circuit
29 second gate driving circuit
36 first transistor
37 second transistor
41 protective film
42 wiring line
60 plasma display panel
62 plasma display panel driving device
64 control unit
66 input terminal
71 scan electrode driving unit
72 sustain electrode driving unit
73 address electrode driving unit
75 recovery switch circuit

### BEST MODE FOR CARRYING OUT THE INVENTION

### First Embodiment

### 1.1 Configuration

1.1.1 Plasma Display

Initially, an entire configuration of a plasma display according to a first embodiment of the present invention will be described.

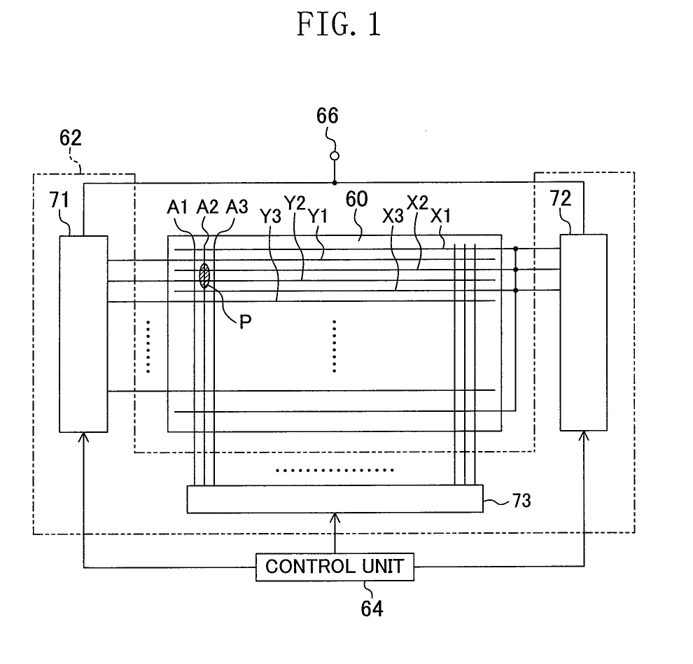

FIG. 1 shows a configuration of the plasma display of the first embodiment. The plasma display comprises a plasma display panel (PDP) 60, a PDP driving device 62, and a control unit 64.

(Plasma Display Panel)

For example, the PDP 60 is of the AC type and has a three-electrode surface discharge structure. An address electrode A1, an address electrode A2, an address electrode A3, . . . , and an address electrode An are provided in a width direction of the panel on a rear substrate of the PDP 60. A sustain electrode X1, a sustain electrode X2, a sustain electrode X3, . . . , and a sustain electrode Xn, and a scan electrode Y1, a scan electrode Y2, a scan electrode Y3, . . . , and a scan electrode Yn, are arranged alternately in a longitudinal direction of the panel on a front substrate of the PDP 60. The sustain electrodes X1 to Xn are connected to each other, and have substantially the same potential. The potentials of the address electrodes A1 to An and the scan electrodes Y1 to Yn can be changed separately one by one.

Discharge cells are provided at intersections of pairs of a sustain electrode and a scan electrode adjacent to each other (e.g., a pair of the sustain electrode X2 and the scan electrode Y2) and the address electrodes (e.g., the address electrode A2) (see, for example, a portion P in FIG. 1). On a surface of each discharge cell, a dielectric material layer made of a dielectric material, a protective layer for protecting the electrodes and the dielectric material layer, and a fluorescent layer containing a fluorescent substance are provided. Gas is enclosed inside the discharge cell. When a predetermined pulse voltage is applied between the sustain electrode, the scan electrode and the address electrode, discharge occurs in the discharge cell. In this case, gas molecules in the discharge cell are deexcited, emitting ultraviolet light. The generated ultraviolet light excites the fluorescent substance in the fluorescent layer provided on the surface of the discharge cell, thereby generating fluorescence. Thus, the discharge cell emits light.

(PDP Driving Device)

The PDP driving device 62 includes a scan electrode driving unit 71, a sustain electrode driving unit 72, and an address electrode driving unit 73 for driving the respective electrodes of the PDP 60.

An input terminal 66 of the scan electrode driving unit 71 and the sustain electrode driving unit 72 is connected to a power supply unit (not shown). The power supply unit initially converts an alternating current from an external utility alternating-current power supply into a constant direct-current voltage (e.g., 400 V). Next, the converted direct-current voltage is converted into a predetermined sustain voltage Vs by a direct current-direct current (DC-DC) converter. The sustain voltage Vs is applied to the PDP driving device 62. Thereby, the potential of the input terminal 66 is maintained to be higher by the sustain voltage Vs than a ground potential (=0).

Output terminals of the scan electrode driving unit 71 are separately connected to the respective scan electrodes Y1 to Yn of the PDP 60. The scan electrode driving unit 71 separately changes the potentials of the scan electrodes Y1 to Yn.

Output terminals of the sustain electrode driving unit 72 are connected to the respective sustain electrodes X1 to Xn of the PDP 60. The sustain electrode driving unit 72 uniformly changes the potentials of the sustain electrodes X1 to Xn.

The address electrode driving unit 73 is separately connected to the address electrodes A1 to An of the PDP 60. The address electrode driving unit 73 generates a signal pulse voltage based on an externally input video signal, and applies the signal pulse voltage to a selected one or more of the address electrodes A1 to An.

The PDP driving device 62 controls the potential of each electrode of the PDP 60 in accordance with the Address Display-period Separation (ADS) method. The ADS method is a type of sub-field method. For example, an image is transmitted on a field-by-field basis and at intervals of 1/60 sec (=about 16.7 msec) in Japanese television broadcasting. Thereby, a display time per field is constant. In the sub-field method, each field is divided into a plurality of sub-fields. In the ADS method, the same three periods (a reset period, an address period, and a discharge sustaining period) are set for each sub-field for all discharge cells in the PDP 60. The length of the discharge sustaining period varies from sub-field to sub-field. Different pulse voltages are applied to a discharge cell during the reset period, the address period and the discharge sustaining period as follows.

During the reset period, a reset pulse voltage is applied between the sustain electrodes X1 to Xn and the scan electrodes Y1 to Yn. Thereby, all the discharge cells have uniform wall charge.

During the address period, the scan electrode driving unit 71 successively applies a scan pulse voltage to the scan electrodes Y1 to Yn. At the same time when the scan pulse voltage is applied, the address electrode driving unit 73 applies a signal pulse voltage to a selected address electrode. An address electrode to which the signal pulse voltage is to be applied is selected based on an externally input video signal. When the scan pulse voltage is applied to a scan electrode and the signal pulse voltage is applied to an address electrode, discharge occurs in a discharge cell located at the intersection of the scan electrode and the address electrode. New wall charge is accumulated on a surface of the discharge cell in which discharge occurs.

During the discharge sustaining period, the scan electrode driving unit 71 and the sustain electrode driving unit 72 alternately apply a discharge sustaining pulse voltage to the scan electrodes Y1 to Yn and the sustain electrodes X1 to Xn. Thereby, discharge is sustained in a discharge cell in which wall charge has been accumulated during the address period, so that light is emitted. The length of the discharge sustaining period varies from sub-field to sub-field. Therefore, a light emission duration per field of a discharge cell, i.e., the luminance of the discharge cell, is adjusted by selecting a sub-field in which light emission is to be performed.

The scan electrode driving unit 71, the sustain electrode driving unit 72 and the address electrode driving unit 73 each include a switching inverter. The control unit 64 performs a switching control with respect to each drive unit. Thereby, a reset pulse voltage, a scan pulse voltage, a signal pulse voltage and a discharge sustaining pulse voltage are generated in respective predetermined waveforms and at respective timings. The control unit 64 also selects an address electrode to which the signal pulse voltage is to be applied, based on an externally input video signal. Moreover, the control unit 64 determines the length of the discharge sustaining period after application of the signal pulse voltage, i.e., a sub-field in which the signal pulse voltage is to be applied. As a result, the discharge cells emit light with respective appropriate luminances. Thus, video corresponding to a video signal is reproduced on the PDP 60.

1.1.2 Scan Electrode Driving Unit

Next, the electrode driving units will be described. The scan electrode driving unit 71 and the sustain electrode driving unit 72 are basically the same circuits. Therefore, the scan electrode driving unit 71 will be hereinafter described.

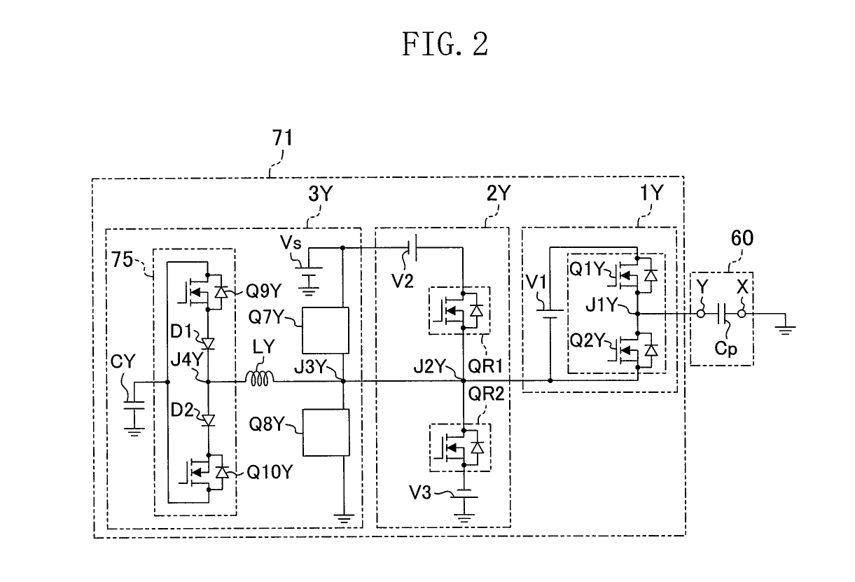

FIG. 2 shows a detailed configuration of the scan electrode driving unit 71. FIG. 2 also shows an equivalent circuit of the PDP 60. The scan electrode driving unit 71 includes a scan pulse generating unit 1Y, a reset pulse generating unit 2Y, and a discharge sustaining pulse generating unit 3Y, each of which includes a switching inverter. The PDP 60 is represented by an equivalent stray capacitance Cp (the panel capacitance of the PDP) between a sustain electrode X and a scan electrode Y, and a path through which a current flows in the PDP 60 during discharge in a discharge cell is not shown. In FIG. 2, a sustain electrode driving unit connected to the sustain electrode X is not shown, and the sustain electrode X is grounded.

(Scan Pulse Generating Unit)

The scan pulse generating unit 1Y includes a first constant voltage source V1, a high-side scan switch Q1Y, and a low-side scan switch Q2Y.

In the first constant voltage source V1, the positive potential is maintained at a voltage that is higher by a constant voltage V1 than the negative potential by, for example, a DC-DC converter (not shown) based on the sustain voltage Vs applied form the power supply unit.

The high-side scan switch Q1Y and the low-side scan switch Q2Y each include, for example, a Metal-Oxide film-Semiconductor Field Effect Transistor (MOSFET). Alternatively, they may each include an Insulated Gate Bipolar Transistor (IGBT) or a bipolar transistor.

The positive terminal of the first constant voltage source V1 is connected to the drain of the high-side scan switch Q1Y. The source of the high-side scan switch Q1Y is connected to the drain of the low-side scan switch Q2Y. A connection point J1Y between them is connected to one scan electrode Y of the PDP 60. The source of the low-side scan switch Q2Y is connected to the negative terminal of the first constant voltage source V1.

Here, actually, the same number of the series connection circuits of the high-side scan switch Q1Y and the low-side scan switch Q2Y (each circuit is a portion surrounded by a solid line in FIG. 2) as that of the scan electrodes Y1, Y2, . . . , and Yn, are provided and are connected to the scan electrodes Y1, Y2, . . . , and Yn, respectively.

(Reset Pulse Generating Unit)

The reset pulse generating unit 2Y includes a second constant voltage source V2, a high-side ramp waveform generating unit QR1, a low-side ramp waveform generating unit QR2, and a third constant voltage source V3.

In the second constant voltage source V2, the positive potential is maintained at a voltage that is higher by a predetermined voltage V2 than the sustain voltage Vs applied from the power supply unit, by, for example, a DC-DC converter.

In the third constant voltage source V3, the positive potential is maintained at a voltage that is higher by a predetermined voltage V3 than the negative potential by, for example, a DC-DC converter based on the sustain voltage Vs applied from the power supply unit.

The high-side ramp waveform generating unit QR1 and the low-side ramp waveform generating unit QR2 each include, for example, an N-channel MOSFET (NMOS). The gate and drain of the NMOS are connected via a capacitor. When the high-side ramp waveform generating unit QR1 and the low-side ramp waveform generating unit QR2 go to the ON state, the drain-source voltage changes to zero at a substantially constant rate.

The positive terminal of the second constant voltage source V2 is connected to the drain of the high-side ramp waveform generating unit QR1. The source of the high-side ramp waveform generating unit QR1 is connected to the negative terminal of the first constant voltage source V1. The negative terminal of the second constant voltage source V2 is connected to the positive terminal of the sustain voltage source Vs of the discharge sustaining pulse generating unit 3Y. The drain of the low-side ramp waveform generating unit QR2 is connected to the negative terminal of the first constant voltage source V1, and the source of the low-side ramp waveform generating unit QR2 is connected to the negative terminal of the third constant voltage source V3. The positive terminal of the third constant voltage source V3 is grounded. The connection point of the source of the high-side ramp waveform generating unit QR1 and the drain of the low-side ramp waveform generating unit QR2 is a connection node J2Y.

(Discharge Sustaining Pulse Generating Unit)

The discharge sustaining pulse generating unit 3Y includes a series circuit of a high-side sustain switch Q7Y and a low-side sustain switch Q8Y, a recovery inductor LY, a recovery switch circuit 75, and an energy-recovery capacitor CY.

In the sustain voltage source Vs, the positive potential is maintained at a voltage that is higher by a constant voltage Vs (sustain voltage) than the negative potential. The positive terminal of the sustain voltage source Vs is connected to the drain of the high-side sustain switch Q7Y, and the source of the high-side sustain switch Q7Y is connected to the drain of the low-side sustain switch Q8Y. The source of the low-side sustain switch Q8Y is connected to the negative terminal of the sustain voltage source Vs. The negative terminal of the sustain voltage source Vs is, for example, at 0 V (grounded state). An output node J3Y where the high-side sustain switch Q7Y and the low-side sustain switch Q8Y are connected, is connected as an output node of the discharge sustaining pulse generating unit 3Y to the negative terminal of the first constant voltage source V1. A path from the output node J3Y of the discharge sustaining pulse generating unit 3Y to the drain of the low-side scan switch Q2Y is hereinafter referred to as a “discharge sustaining pulse transmission path”.

(BiDirectional Switch Device)

In the discharge sustaining pulse generating unit 3Y, particularly, the high-side sustain switch Q7Y and the low-side sustain switch Q8Y each include a bidirectional switch device. In this embodiment and other embodiments below, the “bidirectional switch device” refers to a switch device having any of the following characteristics.

<Characteristic 1>

In the ON state, a current can be caused to flow in both directions, i.e., from the drain to the source and from the source to the drain.

In the OFF state, a current is not caused to flow in both directions, i.e., from the drain to the source and from the source to the drain. During the OFF period, both the absolute maximum rated drain-source voltage and the absolute maximum rated source-drain voltage of the device have sufficient values. (Hereinafter, the absolute maximum rated drain-source voltage and the absolute maximum rated source-drain voltage are referred to as “breakdown voltages of the bidirectional switch device”.)

<Characteristic 2>

In the ON state, a current can be caused to flow from the drain to the source, but not from the source to the drain.

In the OFF state, a current is not caused to flow in both directions, from the drain to the source and from the source to the drain. In the OFF state, both the absolute maximum rated drain-source voltage and the absolute maximum rated source-drain voltage of the device have sufficient values.

Since the high-side sustain switch Q7Y and the low-side sustain switch Q8Y each include a bidirectional switch device, reverse conduction can be prevented even if a high voltage is applied to the high-side sustain switch Q7Y and the low-side sustain switch Q8Y. Therefore, when the high-side sustain switch Q7Y and the low-side sustain switch Q8Y each include a bidirectional switch device, it is no longer necessary to provide a separation switch device that is used in drive devices of conventional PDPs so as to prevent reverse conduction during the reset period. Therefore, the number of parts can be reduced and power loss can be reduced.

(Recovery Switch Circuit)

The recovery switch circuit 75 includes a first recovery diode D1, a second recovery diode D2, a high-side recovery switch Q9Y, and a low-side recovery switch Q10Y. The high-side recovery switch Q9Y and the low-side recovery switch Q10Y each include, for example, a MOS FET. Alternatively, they may each include an IGBT or a bipolar transistor.

The source of the high-side recovery switch Q9Y is connected to the anode of the first recovery diode D1, the cathode of the first recovery diode D1 is connected to the anode of the second recovery diode D2, and the cathode of the second recovery diode D2 is connected to the drain of the low-side recovery switch Q10Y. An end of the recovery inductor LY is connected to the output node J3Y, and the other end thereof is connected to a connection point J4Y of the cathode of the first recovery diode D1 and the anode of the second recovery diode D2. An end of the energy-recovery capacitor CY is connected to the negative terminal of the sustain voltage source Vs, and the other end thereof is connected to the drain of the high-side recovery switch Q9Y and the source of the low-side recovery switch Q10Y.

The energy-recovery capacitor CY has a capacitance that is sufficiently larger than the panel capacitance Cp of the PDP 60. A voltage between both ends of the energy-recovery capacitor CY is maintained at a value that is substantially equal to the half value Vs/2 of the sustain voltage Vs applied from the power supply unit.

### 1.2 Operation

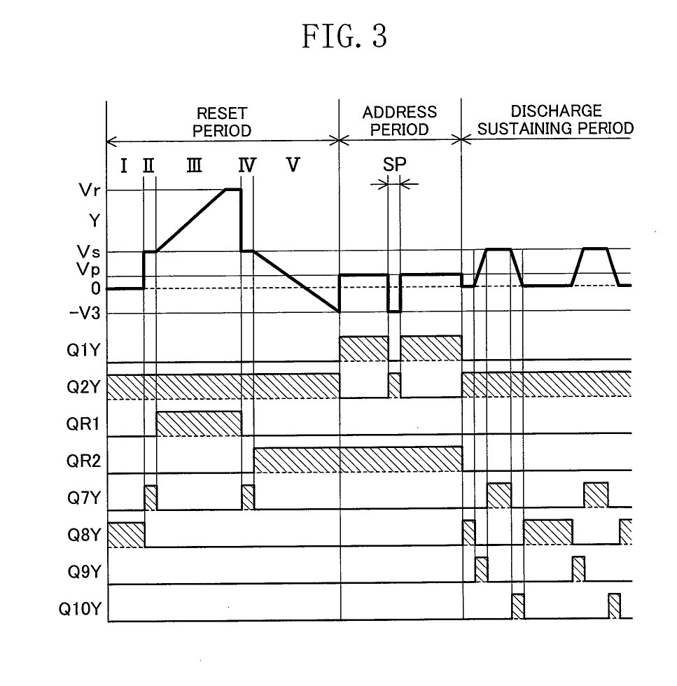

Hereinafter, an operation of the scan electrode driving unit 71 will be described. The operation of the scan electrode driving unit can be divided into the aforementioned three periods, i.e., the reset period, the address period and the discharge sustaining period. FIG. 3 shows waveforms of voltages applied to the scan electrode Y of the PDP 60 during the reset period, the address period and the discharge sustaining period, and states of the switches included in the scan electrode driving unit 71. In FIG. 3, hatched periods indicate periods during which the switches are in the ON state.

1.2.1 Reset Period

The reset period is divided into modes I to V, depending on a change in the reset pulse voltage.

<Mode I>

The low-side scan switch Q2Y and the low-side sustain switch Q8Y are maintained in the ON state. The other switches are maintained in the OFF state. Thereby, the scan electrode Y is maintained at a ground potential (e.g., 0 V).

<Mode II>

The low-side scan switch Q2Y and the high-side sustain switch Q7Y are maintained in the ON state. The other switches are maintained in the OFF state. Thereby, the potential of the scan electrode Y increases to a potential that is higher by the voltage Vs of the sustain voltage source Vs than the ground potential.

<Mode III>

While the low-side scan switch Q2Y is maintained in the ON state, the high-side sustain switch Q7Y is caused to go to the OFF state, and the high-side ramp waveform generating unit QR1 is caused to go to the ON state. The other switches are maintained in the OFF state. Thereby, the potential of the scan electrode Y increases at a constant rate from the ground potential to a potential Vr (hereinafter referred to as an upper limit reset pulse voltage) that is the sum of the voltage Vs of the sustain voltage source Vs and the voltage V2 of the second constant voltage source V2.

Thereby, voltages applied to all the discharge cells of the PDP 60 uniformly increase relatively gradually to the upper limit reset pulse voltage Vr. As a result, all the discharge cells of the PDP 60 accumulate uniform wall charge. In this case, the rate of an increase in the applied voltages is small, so that the light emission of the discharge cells is suppressed to a small level.

<Mode IV>

While the low-side scan switch Q2Y is maintained in the ON state, the high-side ramp waveform generating unit QR1 is caused to go to the OFF state, and the high-side sustain switch Q7Y is caused to go to the ON state. Also, the other switches are maintained in the OFF state. Thereby, the potential of the scan electrode Y decreases from the upper limit reset pulse voltage Vr to a potential that is higher by the voltage Vs of the sustain voltage source Vs than the ground potential.

<Mode V>

While the low-side scan switch Q2Y is maintained in the ON state, the high-side sustain switch Q7Y is caused to go to the OFF state, and the low-side ramp waveform generating unit QR2 is caused to go to the ON state. The other switches are maintained in the OFF state. The potential of the scan electrode Y decreases at a constant rate to a potential −V3 (hereinafter referred to as a lower limit reset pulse voltage) that is lower by the voltage V3 of the third constant voltage source V3 than the ground potential. Therefore, voltages having a polarity reverse to that of voltages applied in modes II to IV are applied to the discharge cells of the PDP 60. Particularly, the applied voltages relatively gradually decrease. Thereby, wall charge is uniformly removed in all the discharge cells, which become uniform. In this case, the rate of a decrease in the applied voltages is small, so that the light emission of the discharge cells is suppressed to a small level.

1.2.2 Address Period

During the address period, in the scan electrode driving unit 71, the low-side ramp waveform generating unit QR2 and the high-side scan switch Q1Y are maintained in the ON state. Therefore, the drain of the high-side scan switch Q1Y is maintained at a potential Vp (hereinafter referred to an upper limit scan pulse voltage Vp) that is higher by the voltage V1 of the first constant voltage source V1 than the lower limit reset pulse voltage −V3, and the source of the low-side scan switch Q2Y is maintained at the lower limit reset pulse voltage −V3.

During the start of the address period, for all the scan electrodes Y, the high-side scan switch Q1Y is maintained in the ON state, and the low-side scan switch Q2Y is maintained in the OFF state. Thereby, the potentials of all the scan electrodes Y are uniformly maintained at the upper limit scan pulse voltage Vp.

Next, the scan electrode driving unit 71 changes the potentials of the scan electrodes Y as follows (see a scan pulse voltage SP of FIG. 3). When a scan electrode Y is selected, the high-side scan switch Q1Y connected to the selected scan electrode Y is caused to go to the OFF state, and the low-side scan switch Q2Y is caused to go to the ON state. Thereby, the potential of the selected scan electrode Y decreases to the lower limit reset pulse voltage −V3. After the potential of the selected scan electrode Y is maintained at the lower limit reset pulse voltage −V3 for a predetermined time, the low-side scan switch Q2Y connected to the selected scan electrode Y is caused to go to the OFF state, and the high-side scan switch Q1Y is caused to go to the ON state. Thereby, the potential of the selected scan electrode Y increases to the upper limit scan pulse voltage Vp again. The scan electrode driving unit 71 successively performs a similar switching operation with respect to the high-side scan switches Q1Y and the low-side scan switches Q2Y connected to the scan electrodes Y. Thereby, the scan pulse voltage SP is successively applied to the scan electrodes Y.

During the address period, when an address electrode A is selected based on an externally input video signal, the potential of the selected address electrode A increases to the upper limit voltage Va of the signal pulse for a predetermined time (not shown).

For example, when the scan pulse voltage SP is applied to a scan electrode Y and the signal pulse voltage is applied to an address electrode A, a voltage between the scan electrode Y and the address electrode A becomes higher than those between other electrodes. Therefore, discharge occurs in a discharge cell located at the intersection of the scan electrode Y and the address electrode A. On a surface of the discharge cell in which discharge occurs, new wall charge is accumulated due to the discharge.

Thereafter, during the discharge sustaining period, the scan electrode driving unit 71 and the sustain electrode driving unit 72 (not shown) alternately apply the discharge sustaining pulse voltage to the scan electrode Y and the sustain electrode X. In this case, discharge is sustained in a discharge cell on which wall charge has been accumulated during the address period, so that the discharge cell emits light.

1.2.3 Discharge Sustaining Period

The discharge sustaining period will be described. The low-side scan switch Q2Y is invariably maintained in the ON state.

Immediately before the high-side recovery switch Q9Y is caused to go to the ON state, the low-side sustain switch Q8Y is caused to go to the ON state, so that the voltage between both ends of the panel capacitance Cp is maintained at 0 V. When the high-side recovery switch Q9Y is caused to go to the ON state, an LC resonance circuit is formed by the energy-recovery capacitor CY, the high-side recovery switch Q9Y, the first recovery diode D1, the recovery inductor LY, and the panel capacitance Cp. Thereby, the voltage between both ends of the panel capacitance Cp increases to Vs. The other switches are maintained in the OFF state.

Next, when the high-side recovery switch Q9Y is caused to go to the OFF state and the high-side sustain switch Q7Y is caused to go to the ON state, the voltage between both ends of the panel capacitance Cp is maintained at Vs. In this case, since the drain-source voltage of the high-side sustain switch Q7Y is 0, the high-side sustain switch Q7Y can be caused to go to the ON state with substantially no loss (the other switch devices are maintained in the OFF state).

After a predetermined time passes, when the high-side sustain switch Q7Y is caused to go to the OFF state and the low-side recovery switch Q10Y is caused to go to the ON state, an LC resonance circuit is formed by the energy-recovery capacitor CY, the low-side recovery switch Q10Y, the second recovery diode D2, the recovery inductor LY and the panel capacitance Cp. Thereby, the voltage between both ends of the panel capacitance Cp decreases to 0.

Next, when the low-side recovery switch Q10Y is caused to go to the OFF state and the low-side sustain switch Q8Y is caused to go to the ON state, the voltage between both ends of the panel capacitance Cp is maintained at 0. In this case, since the drain-source voltage of the low-side sustain switch Q8Y is 0, the low-side sustain switch Q8Y can be caused to go to the ON state with substantially no loss (the other switch devices are maintained in the OFF state).

When the potential of the scan electrode Y increases and decreases, power can be efficiently exchanged between the energy-recovery capacitor CY and the panel capacitance Cp. Therefore, when the discharge sustaining pulse voltage is applied, useless power due to charge and discharge of the panel capacitance Cp can be reduced.

### 1.3 Dual-Gate Semiconductor Device

In order to achieve an operation described above, a switch device included in each of the high-side sustain switch Q7Y and the low-side sustain switch Q8Y needs to be a bidirectional switch that satisfies the aforementioned characteristic 1.

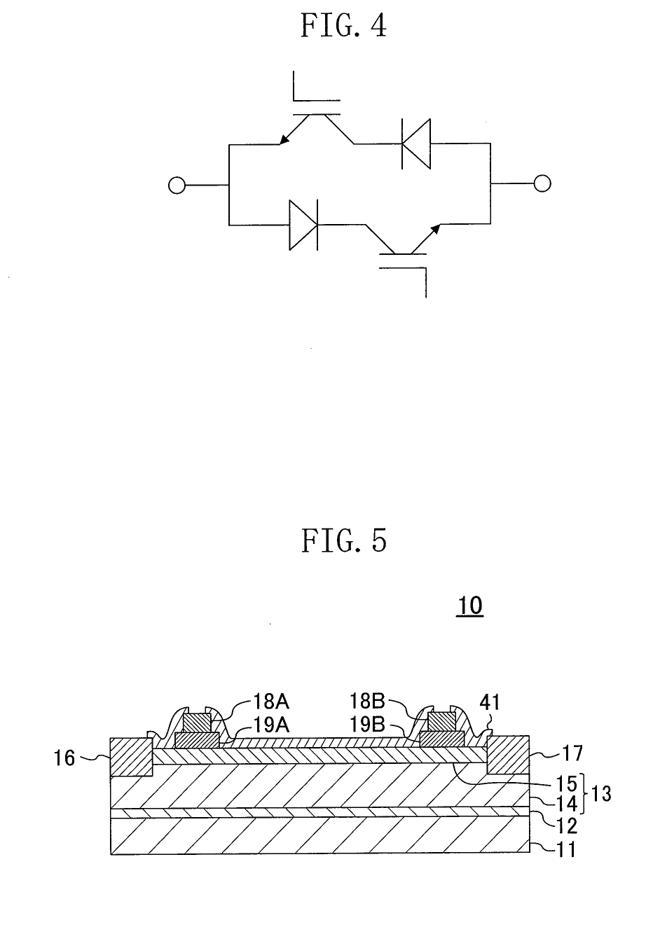

Such a bidirectional switch device can be obtained by connecting a plurality of transistors and diodes as shown in, for example, FIG. 4. However, when a plurality of transistors and diodes are combined as shown in FIG. 4 so as to achieve the bidirectional switch, the number of parts increases. Also, since a plurality of transistors and diodes are provided, a foraward voltage of a diode is added to the ON voltage, so that the conduction loss has a large influence, leading to an increase in power consumption.

In the PDP driving device of this embodiment, the high-side sustain switch Q7Y and the low-side sustain switch Q8Y each include a dual-gate semiconductor device. Therefore, a single device can be used to provide a bidirectional switch, so that the number of parts can be reduced, and therefore, the area of the PDP driving device can be reduced. Also, the power loss can be reduced.

1.3.1 First Dual-Gate Semiconductor Device

FIG. 5 shows a cross-sectional view of a configuration of a first example of a dual-gate semiconductor device 10. As shown in FIG. 5, in the dual-gate semiconductor device 10, a buffer layer 12 having a thickness of 1 μm in which aluminum nitride (AlN) having a thickness of 10 nm and gallium nitride (GaN) having a thickness of 10 nm are alternately laminated is formed on a substrate 11 made of silicon (Si), and a semiconductor multilayer 13 is formed on the buffer layer 12. The semiconductor multilayer 13 includes two semiconductor layers that are successively laminated from the substrate side. The upper semiconductor layer has a band gap larger than that of the lower semiconductor layer. In this embodiment, the lower semiconductor layer is an undoped gallium nitride (GaN) layer 14 having a thickness of 2 μm, and the upper semiconductor layer is an n-type aluminum nitride gallium (AlGaN) layer 15 having a thickness of 20 nm.

Electric charges caused by spontaneous polarization and piezoelectric polarization are generated in the vicinity of a hetero-interface between the GaN layer 14 and the AlGaN layer 15. Thereby, a channel region made of a two-dimensional electron gas (2DEG) layer having a sheet carrier concentration of 1×10¹³ cm⁻² or more and a mobility of 1000 cm²V/sec or more, is generated.

A source electrode (first ohmic electrode) 16 and a drain electrode (second ohmic electrode) 17, which are spaced apart from each other, are formed on the semiconductor multilayer 13. The source electrode 16 and the drain electrode 17 are each a multilayer of titanium (Ti) and aluminum (Al), and make an ohmic contact with the channel region. FIG. 1 shows an example in which, in order to reduce the contact resistance, a portion of the AlGaN layer 15 is removed, the GaN layer 14 is dug at a depth of about 40 nm, and the source electrode 16 and the drain electrode 17 are formed, contacting the interface between the AlGaN layer 15 and the GaN layer 14. Note that the source electrode 16 and the drain electrode 17 may be formed on the AlGaN layer 15.

A first p-type semiconductor layer 19A and a second p-type semiconductor layer 19B are spaced apart from each other and are selectively formed in a region between the source electrode 16 and the drain electrode 17 on the n-type AlGaN layer 15. A first gate electrode 18A is formed on the first p-type semiconductor layer 19A, and a second gate electrode 18B is formed on the second p-type semiconductor layer 19B. The first gate electrode 18A and the second gate electrode 18B are each a multilayer of palladium (Pd) and gold (Au), and make an ohmic contact with the first p-type semiconductor layer 19A and the second p-type semiconductor layer 19B, respectively.

A protective film 41 made of silicon nitride (SiN) is formed, covering the AlGaN layer 15, the first p-type semiconductor layer 19A and the second p-type semiconductor layer 19B. By forming the protective film 41, a defect that causes so-called current collapse can be compensated for, so that current collapse can be hindered.

The first p-type semiconductor layer 19A and the second p-type semiconductor layer 19B each have a thickness of 300 nm and are each made of magnesium (Mg)-doped p-type GaN. A PN junction is formed between each of the first p-type semiconductor layer 19A and the second p-type semiconductor layer 19B, and the AlGaN layer 15. Thereby, when a voltage between the first ohmic electrode and the first gate electrode is, for example, 0 V, a depletion layer spreads from the first p-type GaN layer into the channel region, so that a current can be blocked from flowing into the channel. Similarly, when a voltage between the second ohmic electrode and the second gate electrode is, for example, 0 V or less, a depletion layer spreads from the second p-type GaN layer into the channel region, so that a current can be blocked from flowing into the channel. Thereby, a dual-gate semiconductor device that performs a so-called normally-OFF operation is achieved.

Also, with such a structure, a threshold voltage of the first gate electrode 18A that is applied so as to block a current from flowing between the drain and the source, is about +1.5 V with reference to the source electrode 16, and a threshold voltage of the second gate electrode 18B is about +1.5 V with reference to the drain electrode 17.

Also, the first gate electrode 18A and the second gate electrode 18B contact the AlGaN layer 15 via the first p-type semiconductor layer 19A and the second p-type semiconductor layer 19B, respectively. Therefore, when a forward current flows through the first gate electrode 18A and the second gate electrode 18B, positive holes are injected into the channel region via the first p-type semiconductor layer 19A and the second p-type semiconductor layer 19B. The injected positive holes generate the same amount of electrons in the channel, thereby increasing the effect of generating electrons in the channel region, i.e., the injected positive holes function as donor ions. In other words, the carrier concentration can be modulated in the channel region, so that an operating current can be increased while a normally-OFF operation is performed.

In the dual-gate semiconductor device 10, the first gate electrode 18A and the second gate electrode 18B share a channel region for ensuring voltage withstanding. When two diodes and two transistors are used to form a similar switch device, the area of a channel region for ensuring voltage withstanding for two devices is required. In contrast, the dual-gate semiconductor device 10 can be provided as a switch device with the area of a channel region for a single device. The chip area of the whole switch device can be reduced as compared to when two diodes and two transistors are used.

Hereinafter, an operation of the dual-gate semiconductor device 10 will be described. The dual-gate semiconductor device 10, when it is in the ON state, can cause a current to flow in both directions, i.e., from the drain to the source and from the source to the drain, and when it is in the OFF state, can block a current in both directions, i.e., from the drain to the source and from the source to the drain (i.e., a so-called bidirectional switch operation).

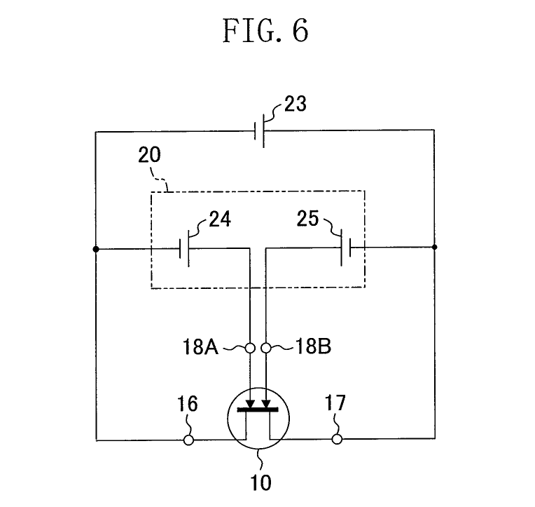

FIG. 6 shows a circuit when the dual-gate semiconductor device 10 of FIG. 5 is caused to perform the bidirectional switch operation. In this case, the dual-gate semiconductor device is driven by a drive unit 20 having a first power supply 24 whose negative terminal is connected to the source electrode 16 and whose positive terminal is connected to the first gate electrode 18A, and a second power supply 25 whose negative terminal is connected to the drain electrode 17 and whose positive terminal is connected to the second gate electrode 18B. Note that an output of the first power supply 24 is represented by Vg1, and an output of the second power supply 25 is represented by Vg2. Note that FIG. 6 shows an example in which the negative terminal of a load power supply 23 is connected to the source electrode 16 of the dual-gate semiconductor device 10, and the positive terminal is connected to the drain electrode 17, for illustrative purposes.

In order to block both a current flowing from the source electrode 16 to the drain electrode 17 and a current flowing form the drain electrode 17 to the source electrode 16, a voltage that is lower than or equal to the threshold voltage of the first gate electrode 18A with reference to the source electrode 16 is applied to the first gate electrode 18A, so that a depletion layer spreads from the first p-type semiconductor layer 19A into the channel region, thereby pinching off the channel region. At the same time, a voltage that is lower than or equal to the threshold voltage of the second gate electrode 18B with reference to the drain electrode 17 is applied to the second gate electrode 18B, so that a depletion layer spreads from the second p-type semiconductor layer 19B into the channel region, thereby pinching off the channel region. Specifically, Vg1 and Vg2 are assumed to be 0 V, for example. By such an operation, when the potential of the drain electrode 17 is higher than the potential of the source electrode 16, a depletion layer spreads from the first p-type semiconductor layer 19A into the channel region, so that a current can be blocked from flowing from the drain electrode 17 to the source electrode 16. Similarly, when the potential of the source electrode 16 is higher than the potential of the drain electrode 17, a depletion layer spreads from the second p-type semiconductor layer 19B into the channel region, so that a current can be blocked from the source electrode 16 into the drain electrode 17.

In order to cause a current to flow in both directions, a voltage that is higher than the threshold voltage of the first gate electrode 18A with reference to the source electrode 16 is applied to the first gate electrode 18A, so that the depletion layer spreading from the first p-type semiconductor layer 19A is reduced, thereby causing the channel region to be in the conductive state, and at the same time, a voltage that is higher than the threshold voltage of the second gate electrode 18B with reference to the drain electrode 17 is applied to the second gate electrode 18B, so that the depletion layer spreading from the second p-type semiconductor layer 19B is reduced, thereby causing the channel region to be in the conductive state. Specifically, for example, Vg1 and Vg2 are set to be 5 V. With such an operation, a current can be caused to flow in both directions between the source electrode 16 and the drain electrode 17.

Also, when a current flows in both directions, since no diode exists on the channel, an increase in ON voltage due to the foraward voltage of a diode does not occur in the bidirectional switch. Therefore, as compared to a conventional bidirectional switch that includes a diode and a transistor connected in series, the ON voltage can be reduced, and therefore, PDP drive power can be reduced.

Also, the dual-gate semiconductor device 10, when it is in ON state, causes a current to flow in one direction between the drain electrode 17 and the source electrode 16, and blocks a current in the other direction, and when it is in the OFF state, blocks a current in both directions. Thus, the dual-gate semiconductor device 10 can perform a reverse blocking operation.

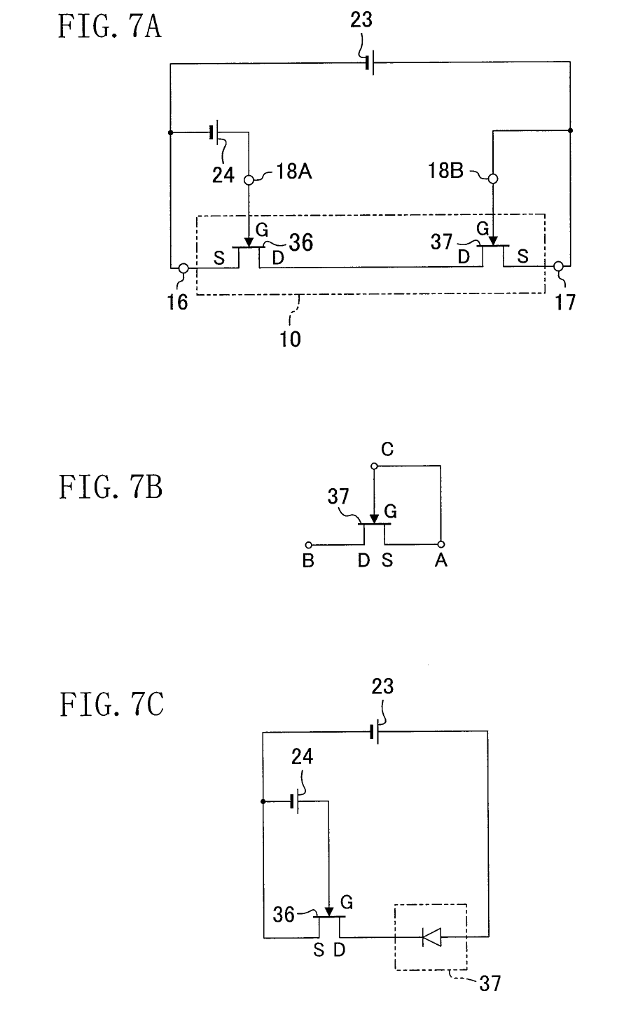

Regarding the reverse blocking operation, firstly, a case where a voltage that is higher than the threshold voltage of the first gate electrode 18A is applied to the first gate electrode 18A, and a voltage that is lower than the threshold voltage of the second gate electrode 18B is applied to the second gate electrode 18B, will be described. The dual-gate semiconductor device of FIG. 5 is represented by an equivalent circuit, i.e., a circuit in which a first transistor 36 and a second transistor 37 are connected in series, as shown in FIG. 7(a). In this case, the source (S) of the first transistor 36 corresponds to the source electrode 16 of the dual-gate semiconductor device, the gate (G) of the first transistor 36 corresponds to the first gate electrode 18A, the source (S) of the second transistor 37 corresponds to the drain electrode 17 of the dual gate transistor, and the gate (G) of the second transistor 37 corresponds to the second gate electrode 18B. FIG. 7 shows an example in which the negative terminal of the load power supply 23 is connected to the source electrode 16 of the dual-gate semiconductor device, and the positive terminal is connected to the drain electrode 17, for illustrative purposes.

In such a circuit, for example, Vg1 is assumed to be 5 V and Vg2 is assumed to be 0 V. In this case, since a state in which Vg2 is 0 V is equivalent to a state in which the gate and source of the second transistor 37 are short-circuited, the second transistor of the dual-gate semiconductor device can be considered as a circuit as shown in FIG. 7(b).

Hereinafter, in FIG. 7(b), the source (S) of a transistor is represented by an A-terminal, the drain (D) is represented by a B-terminal, and the gate (G) is represented by a C-terminal.

When the potential of the B-terminal is higher than the potential of the A-terminal, the transistor can be considered as a transistor in which the A-terminal is the source and the B-terminal is the drain. In this case, a voltage between the C-terminal (gate) and the A-terminal (source) is 0 V, which is lower than the threshold voltage, so that a current does not flow from the B-terminal (drain) to the A-terminal (source).

On the other hand, when the potential of the A-terminal is higher than the potential of the B-terminal, the transistor can be considered as a transistor in which the B-terminal is the source and the A-terminal is the drain. In this case, since the C-terminal (gate) and the A-terminal (drain) have the same potential, when the potential of the A-terminal is higher than or equal to the threshold voltage with reference to the B-terminal, a voltage that is higher or equal to the threshold voltage with reference to the B-terminal (source) is applied to the gate, so that a current can be caused to flow from the A-terminal (drain) to the B-terminal (source).

In other words, when the gate and source of the transistor are short-circuited, the transistor functions as a diode, where the drain is the cathode and the source is the anode, and the threshold voltage of the transistor is the foraward voltage.

Therefore, the second transistor 37 of FIG. 7(a) can be considered as a diode. Therefore, FIG. 7(a) can be represented by an equivalent circuit in which the first transistor and the diode are connected in series, as shown in FIG. 7(c). In the equivalent circuit of FIG. 7(c), when the potential of the drain of the switch device is higher than the potential of the source, 5 V is applied to the gate of the first transistor 36, so that the first transistor 36 is in the ON state, and therefore, a current can be caused to flow from the drain to the source. Note that an ON voltage occurs due to the foraward voltage of the diode. Also, when the potential of the source of the switch device is higher than the potential of the drain, the diode made of the second transistor 37 withstands the voltage, and blocks a current from flowing from the source to the drain of the switch device. Specifically, by applying to the first gate electrode 18A a voltage that is higher than or equal to the threshold voltage, and to the second gate electrode 18B a voltage that is lower than or equal to the threshold voltage, a so-called reverse blocking operation can be performed.

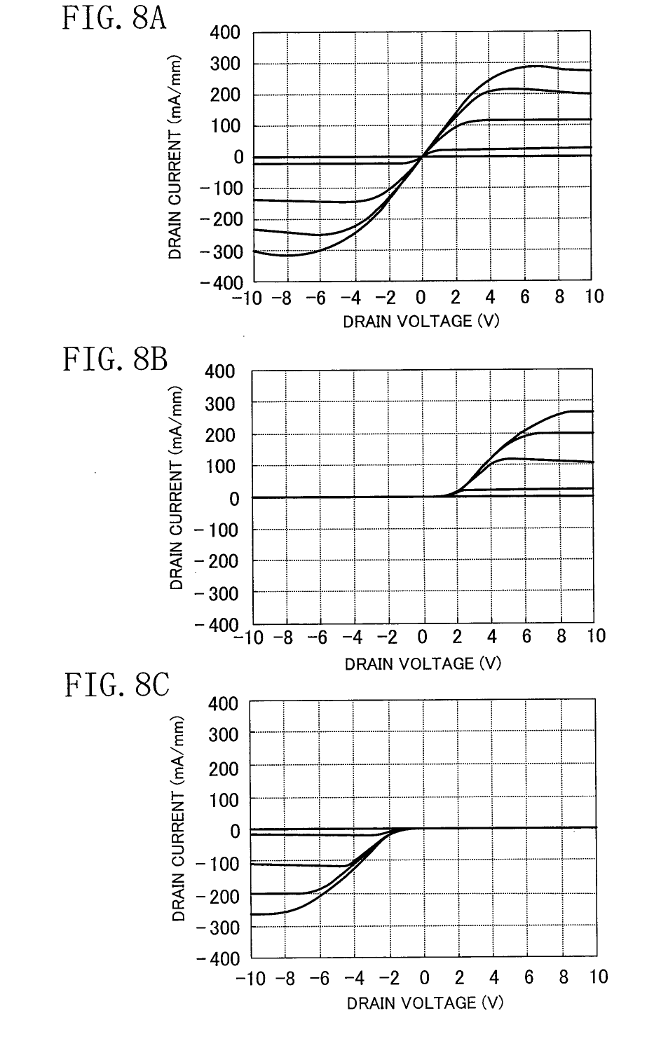

FIGS. 8(a) to 8(c) show operational characteristics when the dual-gate semiconductor device 10 performs the bidirectional switch operation and the reverse blocking operation. In FIG. 8, the horizontal axis represents the voltage (Vds) of the drain electrode 17 with reference to the source electrode 16. The vertical axis represents currents (Ids) flowing between the drain electrode 17 and the source electrode 16, where the direction of a current from the drain electrode 17 to the source electrode 16 is a positive direction.

FIG. 8(a) shows characteristics when the output Vg1 of the first power supply is assumed to be equal to the output Vg2 of the second power supply, and Vg1 and Vg2 are assumed to be 0 V, 1 V, 2 V, 3 V, 4 V and 5 V. As shown in FIG. 8, when Vg1 and Vg2 are 0 V, a bidirectional current is obviously blocked, and when Vg1 and Vg2 are 5 V, a bidirectional current obviously flows. Thus, the operation of a bidirectional switch is achieved.

FIG. 8(b) shows Ids-Vds characteristics when Vg2 is assumed to be 0 V, and Vg1 is assumed to be 0 V, 1 V, 2 V, 3 V, 4 V and 5 V. As shown in FIG. 8(b), when Vg1 is 5 V, then if Vds is a positive voltage, a current flows. When Vds is a negative voltage, a current is blocked. This operation is the same as an operation of a diode where the source electrode is the cathode and the drain electrode is the anode.

FIG. 8(c) shows Ids-Vds characteristics when Vg1 is assumed to be 0 V, and Vg2 is assumed to be 0 V, 1 V, 2 V, 3 V, 4 V and 5 V. As shown in FIG. 8(c), when Vg2 is 5 V, then if Vds is a negative voltage, a current flows. When Vds is a positive voltage, a current is blocked. This operation is the same as an operation of a diode where the source electrode is the anode and the drain electrode is the cathode.

As described above, the dual-gate semiconductor device 10 of this embodiment can be caused to perform the bidirectional switch operation that blocks and passes a bidirectional current, and the reverse blocking operation, depending on the gate bias conditions. Also, during the reverse blocking operation, the directions of the current flow can be switched.

When the dual-gate semiconductor device is caused to perform the reverse blocking operation, it is only necessary to adjust a voltage applied to the first gate electrode 18A or the second gate electrode 18B. However, when the dual-gate semiconductor device is caused to perform the bidirectional switch operation, a drive unit for applying a voltage to each of the first gate electrode 18A and the second gate electrode 18B is required.

1.3.2 Second Dual-Gate Semiconductor Device

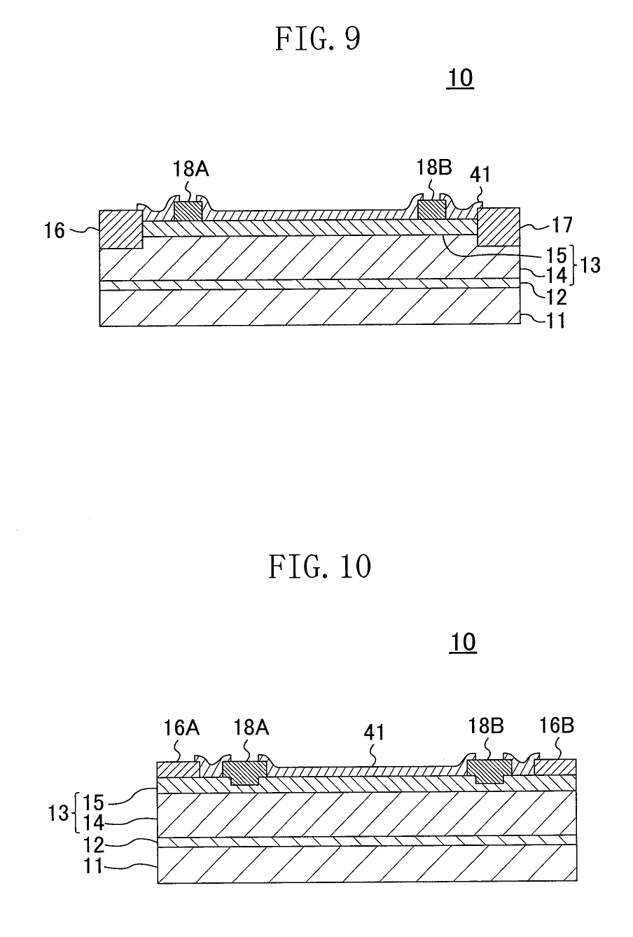

FIG. 9 shows a cross-sectional view of a configuration of a second example of the dual-gate semiconductor device 10. In FIG. 9, the same parts as those of FIG. 5 are indicated by the same reference symbols and will not be described.

As shown in FIG. 9, the second dual-gate semiconductor device is different from the first dual-gate semiconductor device in that the first p-type semiconductor and the second p-type semiconductor are removed, a first gate electrode and a second gate electrode are formed on an AlGaN layer, and since the first gate electrode and the second gate electrode have a Schottky junction with the AlGaN layer, a normally-OFF operation is allowed, and the AlGaN layer has a thin thickness (e.g., about 5 nm).

With such a structure, a dual-gate semiconductor device that can perform the bidirectional switch operation and the reverse blocking switch operation as with the first dual-gate semiconductor device can be achieved.

Also, the electron carrier concentration of the channel region can be increased by increasing the thickness of the AlGaN layer or increasing the Al molar ratio of the AlGaN layer. Therefore, the resistance of the channel region is decreased, so that the on-state resistance of the dual-gate semiconductor device is reduced, thereby making it possible to reduce the power consumption of the scan electrode drive. Note that, in the case of such a structure, a normally-ON dual-gate semiconductor device is provided, so that the threshold voltage is a negative voltage. Therefore, when the dual-gate semiconductor device is used together with the switch device of the scan electrode driving unit, a voltage lower than the threshold voltage is applied to the first gate and the second gate before a voltage is applied to the source or drain of the dual-gate semiconductor device, so as to prevent a short-circuit failure due to the dual-gate semiconductor device. Thereby, it is possible to operate a PDP driving device employing a normally-ON dual-gate semiconductor device.

1.3.3 Third Dual-Gate Semiconductor Device

FIG. 10 shows a cross-sectional view of a configuration of a third example of the dual-gate semiconductor device 10. In FIG. 10, the same parts as those of FIG. 5 are indicated by the same reference symbols and will not be described.

As shown in FIG. 10, the third dual-gate semiconductor device is different from the first dual-gate semiconductor device in that the first p-type semiconductor and the second p-type semiconductor are removed, two concave portions are formed in an AlGaN layer 15, a first gate electrode 18A and a second gate electrode 18B are formed, contacting a bottom surface of the concave portion, and the first gate electrode 18A and the second gate electrode 18B have a Schottky junction with the AlGaN layer 15. As shown in FIG. 10, the thickness of the AlGaN layer 15 is partially reduced, so that the threshold voltage of the gate can be caused to be a positive voltage while suppressing a reduction in electron carrier concentration of the channel layer due to a reduction in thickness of the AlGaN layer 15. Therefore, it is possible to achieve a dual-gate semiconductor device that has a low on-state resistance and can perform a normally-OFF operation.

Note that the substrate of each dual-gate semiconductor device may be made of materials other than Si as long as a nitride semiconductor can be grown. Examples of the substrate material include GaN, sapphire, silicon carbide (SiC), zinc oxide (ZnO), gallium arsenide (GaAs), gallium phosphide (GaP), indium phosphide (InP), lithium gallium oxide (LiGaO₂), lithium aluminum oxide (LiAlO₂), or a mixed crystal thereof.

Although Pd and Au are used as materials for the gate electrode, metals other than Pd may be used as long as an ohmic junction with the p-type semiconductor and a Schottky junction with the AlGaN layer can be formed. Examples of the metals include Ni, Pt, indium tin oxide, ZnInSnO, GaInSnO, and the like.

Also, in the dual-gate semiconductor device of each example, when an ON voltage is applied to the first gate electrode 18A or the second gate electrode 18B, a voltage that is higher than or equal to the foraward voltage (about 1 V) of a diode including the first gate electrode 18A or the second gate electrode 18B and the AlGaN layer 15, is applied. Therefore, a current flows from the first gate electrode 18A or the second gate electrode 18B to the source electrode 16 or the drain electrode 17, so that the gate drive power of the switch device increases. Therefore, it is necessary to drive the dual-gate semiconductor device where the ON voltage applied to the first gate electrode 18A or the second gate electrode 18B is set to be about 1 V. In this case, the dual-gate semiconductor device is likely to malfunction due to an influence of noise generated in the PDP driving device. In order to avoid the malfunction, the first gate electrode 18A or the second gate electrode 18B may be formed via an insulating film on the AlGaN layer 15. In this case, the insulating film may be made of silicon oxide (SiO₂), hafnium oxide (HfO₂), aluminum oxide (Al₂O₃), tantalum oxide (Ta₂O₅), aluminum nitride (AlN), silicon nitride (SiN), or the like. With such a structure, a gate electrode having a so-called Metal-Insulator-Semiconductor (MIS) structure (representative example: MOS FET) is formed. Therefore, even if a high ON voltage is applied to the first gate electrode 18A or the second gate electrode 18B, a current that flows from the gate electrode to which the high ON voltage is applied to the source electrode or the drain electrode, can be suppressed.

### 1.4 Gate Driving Circuit Of Dual-Gate Semiconductor Device

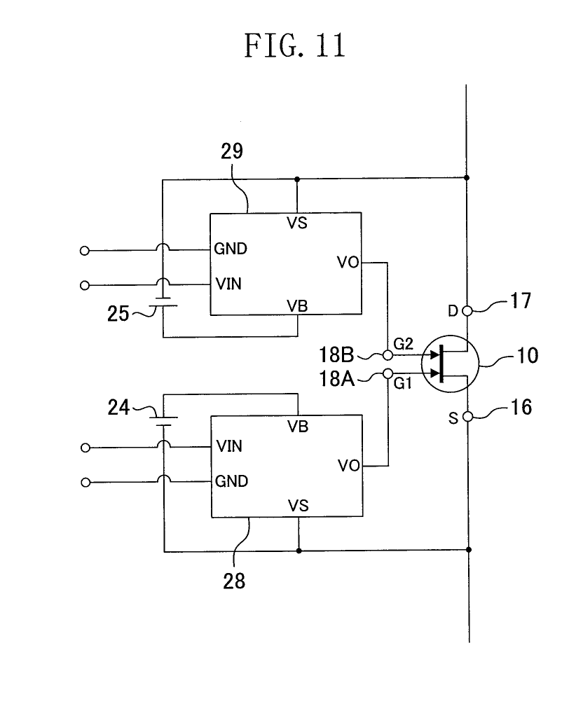

FIG. 11 shows a specific example of the drive unit 20 for driving the dual-gate semiconductor device. The first gate electrode 18A of the dual-gate semiconductor device 10 is driven by a first gate driving circuit 28, and the second gate electrode 18B is driven by a second gate driving circuit 29.

When a bidirectional switch having characteristic 1 is implemented using the dual-gate semiconductor device, and is applied to the high-side sustain switch Q7Y or the low-side sustain switch Q8Y, a gate driving circuit as hereinafter described is employed.

The first gate driving circuit 28 and the second gate driving circuit 29 are each a gate driving circuit that outputs a gate bias voltage via a VO-terminal based on a signal that has been transmitted via an insulated signal transmission circuit that transmits a signal input to a VIN-terminal with the insulated signal transmission circuit being electrically isolated from the VIN-terminal. The insulated signal transmission circuit may include a photocoupler that can transmit a light signal, can transmit a signal with the input being electrically isolated from the output, and can perform high-speed switching. Note that the insulated signal transmission circuit may include an isolated coupler that transmits a signal using a transformer or an isolated coupler that transmits a signal using a capacitor.

In the first gate driving circuit 28 and the second gate driving circuit 29, the VB-terminal, the VS-terminal and the VO-terminal are isolated from the VIN-terminal and the GND-terminal. In the first gate driving circuit 28 and the second gate driving circuit 29, when a voltage between the VIn-terminal and the GND-terminal is lower than a predetermined voltage, the VO-terminal is connected to the VS-terminal, and the VO-terminal is not connected to the VB-terminal. Also, when a voltage between the VIN-terminal and the GND-terminal is higher than or equal to the predetermined voltage, the VO-terminal is not connected to the VS-terminal, and the VO-terminal is connected to the VB-terminal. The VO-terminal of the first gate driving circuit 28 is connected to the first gate electrode 18A, and the VS-terminal is connected to the negative terminals of the source electrode 16 and the first power supply 24, and the VB-terminal is connected to the positive terminal of the first power supply 24. Also, the VO-terminal of the second gate driving circuit is connected to the second gate electrode 18B, the VS-terminal is connected to the negative terminals of the drain electrode 17 and the second power supply 25, and the VB-terminal is connected to the positive terminal of the second power supply 25. Note that the first power supply 24 and the second power supply 25 are isolated from the reference potential of the PDP driving device.

By applying a predetermined voltage between the VIN-terminal and the GND-terminal of the first gate driving circuit 28, a voltage of the first power supply 24 with reference to the source electrode 16 can be applied to the first gate electrode 18A. Also, similarly, by applying a predetermined voltage between the VIN-terminal and the GND-terminal of the second gate driving circuit, a voltage of the second power supply 25 with reference to the drain electrode 17 can be applied to the second gate electrode 18B.

In the drive unit 20 of FIG. 11, the first power supply 24 and the second power supply 25 each include a power supply that is isolated from the reference potential of the PDP driving device. Therefore, even when the potential of the source electrode 16 or the drain electrode 17 of the dual-gate semiconductor device 10 is different from the reference potential of the control unit 64 of FIG. 1, a bias voltage can be applied to the first gate electrode 18A and the second gate electrode 18B. As a result, the drive unit 20 can be used to control the dual-gate semiconductor device 10.

### 1.5 First Example in which Dual-Gate Semiconductor Device is Used

An example in which the dual-gate semiconductor device of 1.3 is applied to the scan electrode driving unit 71 will be described.

1.5.1 Scan Electrode Driving Unit

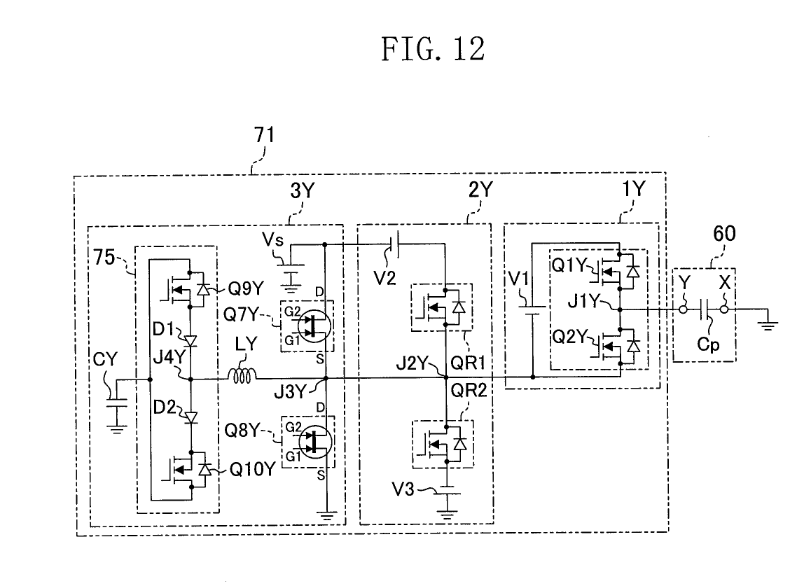

FIG. 12 shows an exemplary PDP driving device to which the dual-gate semiconductor device is applied. In the PDP driving device of this embodiment, the high-side sustain switch Q7Y and the low-side sustain switch Q8Y of the scan electrode driving unit 71 each include a dual-gate semiconductor device. In FIG. 12, a drain D is the drain electrode 17 of the dual-gate semiconductor device, a source S is the source electrode 16, a first gate G1 is the first gate electrode 18A, and a second gate G2 is the second gate electrode 18B. Note that any of the aforementioned dual-gate semiconductor devices can be similarly used.

Thus, since the high-side sustain switch Q7Y and the low-side sustain switch Q8Y each include a dual-gate semiconductor device, it is no longer necessary to provide a separation switch device that is used in conventional scan electrode driving units so as to block reverse conduction during the reset period, so that the number of parts and power loss can be reduced.

Also, when a bidirectional switch includes a conventional semiconductor device made of silicon (Si), it is difficult to reduce the on-state resistance due to limitation of the material Si. Therefore, in order to overcome the limitation of the material to reduce conduction loss, a bidirectional switch is used that is made of a wide-gap semiconductor, such as a nitride semiconductor (a representative example: GaN), silicon carbide (SiC) or the like, thereby making it possible to further reduce the conduction loss, and reduce the power loss of the scan electrode driving unit.

1.5.2 First Operation

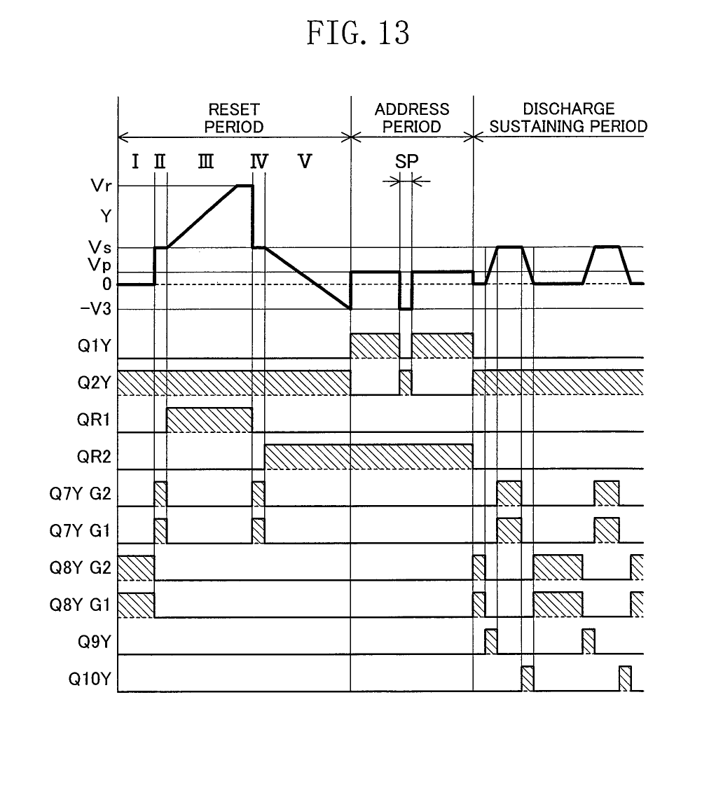

FIG. 13 shows a first operation of the scan electrode driving unit 71 of FIG. 12. As shown in FIG. 13, a period during which each switch is in the ON state is the same as a period during which each switch is in the ON state in FIG. 3.

Note that, since the high-side sustain switch Q7Y and the low-side sustain switch Q8Y each have the first gate (G1) and the second gate (G2), a period during which the first gates G1 and the second gates G2 of the high-side sustain switch Q7Y and the low-side sustain switch Q8Y are in the ON state, will be described. The dual-gate semiconductor device used in the high-side sustain switch Q7Y and the low-side sustain switch Q8Y are in the bidirectional conductive state in which a current flows in both directions when the first gate G1 and the second gate G2 are simultaneously in the ON state, and are in the bidirectionally blocked state in which a current is blocked from flowing in both directions when the first gate G1 and the second gate G2 are simultaneously in the OFF state. Therefore, a period during when the first gate G1 and the second gate G2 of the high-side sustain switch Q7Y are in the ON state is similar to a period during which the high-side sustain switch Q7Y (see 1.2) is the ON state. Also, a period during which the first gate G1 and the second gate G2 of the low-side sustain switch Q8Y are in the ON state is similar to a period during which the low-side sustain switch Q8Y (see 1.2) is in the ON state. Thus, by causing the first gates G1 and the second gates G2 of the high-side sustain switch Q7Y and the low-side sustain switch Q8Y to be simultaneously in the ON state, it is possible to achieve the ON state without generating an ON voltage that would otherwise occur during a reverse blocking operation, so that the power loss of the PDP driving device can be further reduced.

1.5.3 Second Operation

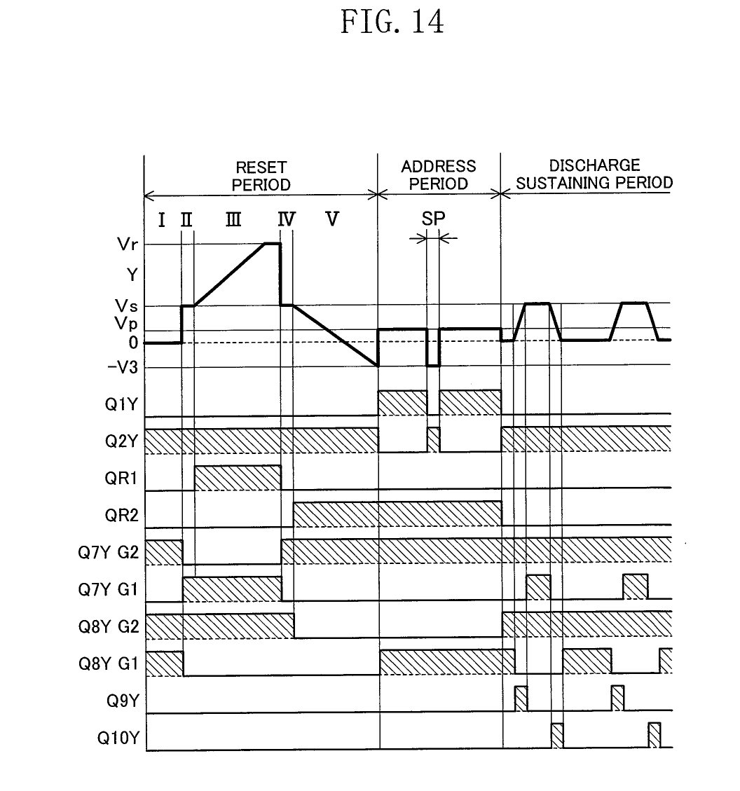

FIG. 14 shows a second operation of the scan electrode driving unit 71 of FIG. 12.

As shown in FIG. 14, in the second operation method, a period during which one of the first gate G1 and the second gate G2 is in the ON state, while the other is in the OFF state, is provided in each of the high-side sustain switch Q7Y and the low-side sustain switch Q8Y each including a dual-gate semiconductor device.

Basically, a period during which the high-side sustain switch Q7Y and the low-side sustain switch Q8Y are in the ON state and a period during which the high-side sustain switch Q7Y and the low-side sustain switch Q8Y are in the OFF state, are the same as those of the first drive method.

Note that, in the high-side sustain switch Q7Y, when it is in the OFF state during periods other than mode III of the reset period, a low-level voltage is applied to the first gate G1, and a high-level voltage is applied to the second gate G2, so that a current from the drain D to the source S is blocked. During mode III of the reset period, a high-level voltage is applied to the first gate G1, and a low-level voltage is applied to the second gate G2, so that a current is blocked from flowing from the source S to the drain D. Also, in the high-side sustain switch Q7Y, when it is in the ON state during mode II of the reset period, a high-level voltage is applied to the first gate G1, and a low-level voltage is applied to the second gate G2, so that a current flows from the drain D to the source S. When it is in the ON state during mode IV, a high-level voltage is applied to the first gate G1, and the low-level voltage is applied to the second gate G2, so that a current flows from the source S to the drain D. When it is in the ON state during the discharge period, a high-level voltage is applied to both the first gate G1 and the second gate G2, so that a current can flow in both directions.

On the other hand, in the low-side sustain switch Q8Y, when it is in the OFF state during mode II, mode III and mode IV of the reset period, a low-level voltage is applied to the first gate G1, and a high-level voltage of the second gate G2 is applied, so that a current flows from the drain D to the source S. When it is in the OFF state during the address period, a high-level voltage is applied to the first gate G1, and a low-level voltage is applied to the second gate G2, so that a current is blocked from flowing from the source S to the drain D. When it is in the OFF state during the mode V of the reset period, a low-level voltage is applied to both the first gate G1 and the second gate G2, so that a current is blocked. Also, when it is in the OFF state during the discharge sustaining period, a low-level voltage is applied to the first gate G1, and a high-level voltage is applied to the second gate G2, so that a current is blocked. When it is in the ON state, a high-level voltage is applied to both the first gate G1 and the second gate G2, so that a current can flow in both directions.

Note that when both the high-side sustain switch Q7Y and the low-side sustain switch Q8Y are in the OFF state, a low-level voltage may be applied to both the first gate G1 and the second gate G2, so that a current is blocked from flowing in both directions.

Note that, during mode II of the reset period, a high-level voltage may be applied to both the first gate G1 and the second gate G2 of the high-side sustain switch Q7Y. During mode II, the panel voltage is increased to Vs by causing a current to flow through the high-side sustain switch Q7Y. Parasitic inductance of circuit wiring causes a voltage in a transit state in which the panel voltage increases from 0 V to Vs. Therefore, when the high-side sustain switch Q7Y is caused to perform a reverse blocking operation, a voltage higher than Vs is likely to be applied to the panel due to electromotive force caused by the inductance. This leads to false discharge in the plasma display panel. When both the first gate G1 and the second gate G2 of the high-side sustain switch Q7Y are caused to be in the ON state, so that a current flows in both directions, transient electromotive force due to the inductance can be caused to flow back to the sustain voltage source Vs via the high-side sustain switch Q7Y, thereby preventing a high voltage from being applied to the panel.

Also, during mode IV of the reset period, both the first gate G1 and the second gate G2 of the high-side sustain switch Q7Y may be caused to be in the ON state. Thereby, as is similar to mode II, electromotive force caused by parasitic inductance of wiring is prevented from being applied to the panel, so that an erroneous operation of the plasma display panel can be prevented.

### 1.6 Summary

In the PDP driving device 62 of this embodiment, since the high-side sustain switch Q7Y and the low-side sustain switch Q8Y each include a dual-gate semiconductor device, reverse conduction during the reset period of the high-side sustain switch Q7Y and the low-side sustain switch Q8Y can be blocked. Therefore, it is no longer necessary to provide a separation switch device used in drive devices of conventional PDPs. In other words, as shown in FIG. 12, only the high-side sustain switch Q7Y and the low-side sustain switch Q8Y exist in a path from the sustain voltage source Vs via the output node J3Y of the discharge sustaining pulse generating unit 3Y to the source of the low-side scan switch Q2Y. Therefore, according to this embodiment, the number of parts and the device area can be reduced in the PDP driving device as compared to conventional devices. Particularly, since a large current flows through the separation switch device during the discharge sustaining period, it is conventionally necessary to provide a large number of separation switch devices connected in parallel. In contrast, according to this embodiment that does not require a separation switch device, the circuit scale can be significantly reduced. Also, since the device area is reduced, the wiring impedance of the substrate can be reduced, so that ringing that is a high-frequency component generated during application of a voltage to a PDP can be reduced, and therefore, the operation margin of the PDP is increased. Moreover, conduction loss due to the separation switch device during the discharge sustaining period is significantly reduced, so that power consumption can be reduced.

Also, when a bidirectional switch includes a conventional semiconductor device made of Si that has been used in conventional PDP driving devices, the limitation of the material Si makes it difficult to reduce the on-state resistance. In order to overcome the limitation of the material to reduce conduction loss, a bidirectional switch is used that is made of a wide-gap semiconductor, such as a nitride semiconductor (a representative example: GaN), silicon carbide (SiC) or the like, thereby making it possible to further reduce the conduction loss, and therefore reduce power consumption.

Also, in a MOSFET as shown in the aforementioned conventional example, a body diode having a PN junction is formed between the drain and the source. Therefore, a so-called recovery current occurs due to the diode during a switching operation of the semiconductor switch. Therefore, there is a limit on a reduction in power consumption.

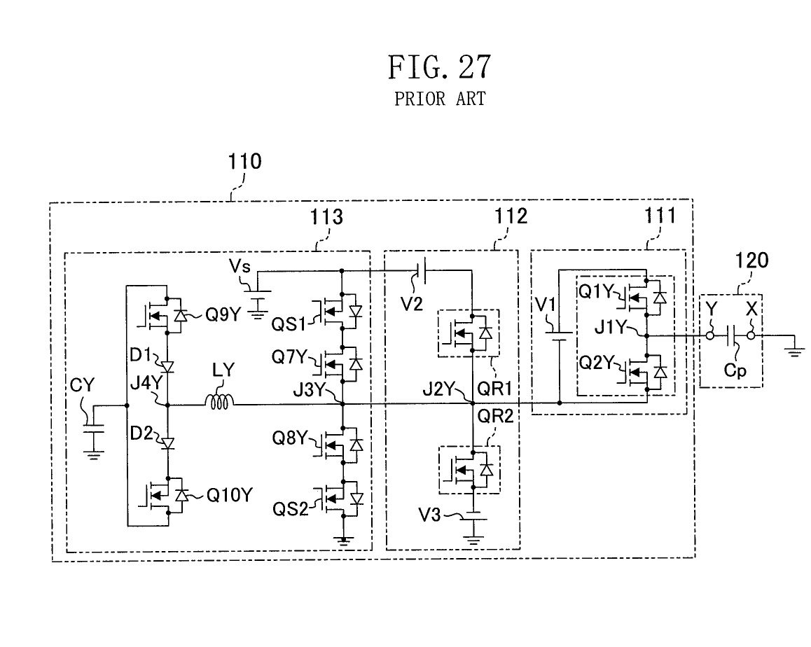

For example, when a separation switch QS1 as shown in FIG. 27 is provided, a current flows from the sustain voltage source Vs to the connection node J2Y via a body diode having the PN junction of the separation switch QS1 (MOSFET) during mode II of the reset period. Next, when mode II is changed to mode III, the potential of the connection node J2Y increases, so that a voltage (reverse bias) reverse to the current flow direction is applied to the body diode of QS1, so that a current is blocked.

In other words, there is an operation that causes a reverse bias to be applied immediately after a current flows through the body diode of the separation switch QS1. At this moment, a recovery current instantaneously occurs that is a current flowing in the reverse direction through the body diode. The product of the generated recovery current and the voltage applied to the body diode is switching loss, which is a portion of the power loss of the PDP driving circuit.

In general, the recovery current of a PN junction diode is generated when minority carriers injected during current passage due to the minority carrier storage effect are ejected during reverse biasing as a backward current against rectification of the diode. Therefore, in PN junction diodes, the occurrence of the recovery current cannot be prevented, so that it is difficult to reduce switching loss.

In the dual-gate semiconductor device of this embodiment, since the P-type semiconductor functions as a gate, substantially no positive holes are injected to the channel as long as a reverse blocking operation is performed using a gate voltage that does not actively cause a current to flow through the gate. Therefore, substantially no positive holes (minority carriers) exist in the channel, so that there is substantially no minority carrier storage effect as described above. As a result, the recovery current is small, so that the switching loss of the PDP driving circuit can be reduced.

Although the present invention has been described particularly based on the configuration of the scan electrode driving unit in this embodiment for the sake of convenience, the concept of the present invention is also similarly applicable to the sustain electrode driving unit and the address electrode driving unit.

### Second Embodiment

Hereinafter, a PDP driving device according to a second embodiment of the present invention will be described with reference to the drawings.

2.1 Scan Electrode Driving Unit

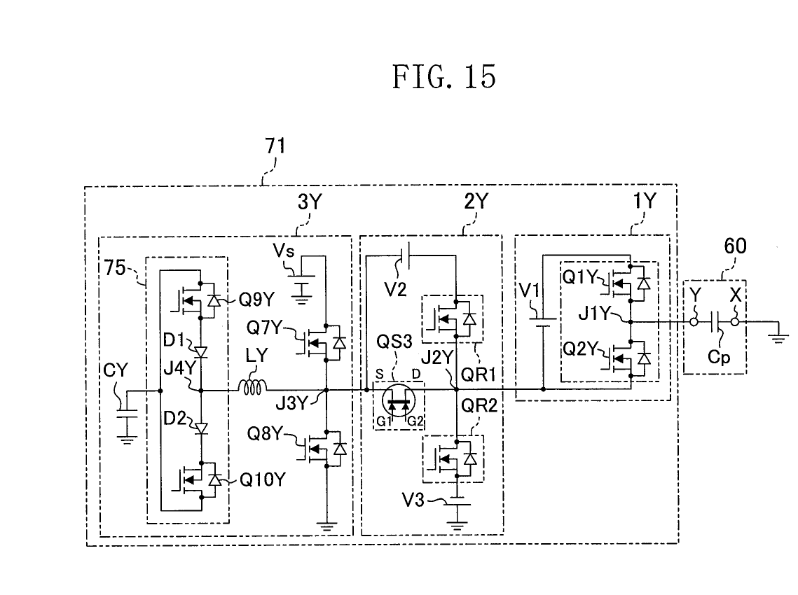

FIG. 15 shows a scan electrode driving unit 71 of the PDP driving device of the second embodiment. In FIG. 15, the same parts as those of FIG. 2 are indicated by the same reference symbols and will not be described.

As shown in FIG. 15, the scan electrode driving unit 71 of this embodiment includes a separation switch QS3 between a connection node J2Y of a high-side ramp waveform generating unit QR1 and a low-side ramp waveform generating unit QR2 of a reset pulse generating unit 2Y, and an output node J3Y of a discharge sustaining pulse generating unit 3Y. Also, the negative terminal of a second constant voltage source V2 is connected to the output node J3Y of the discharge sustaining pulse generating unit 3Y, but not to the positive terminal of a sustain voltage source Vs.

The separation switch QS3 of this embodiment is a switch device including a dual-gate semiconductor device, where the drain D of the dual-gate semiconductor device is connected to the connection node J2Y, and the source S is connected to the output node J3Y of the discharge sustaining pulse generating unit 3Y. Note that the drain D and the source S may be switched.

The dual-gate semiconductor device included in the separation switch QS3 of this embodiment may be any of the dual-gate semiconductor devices shown in the first embodiment. Also, a drive unit for driving the first gate G1 and the second gate G2 may be any of those shown in the first embodiment.

Although FIG. 15 shows an example in which a high-side sustain switch Q7Y and a low-side sustain switch Q8Y each include a MOSFET or the like, the high-side sustain switch Q7Y and the low-side sustain switch Q8Y may each include an IGBT, a bipolar transistor or the like, or alternatively, a dual-gate semiconductor device as in the first embodiment.

Hereinafter, an operation of the PDP driving device of the second embodiment will be described. As a method for driving the PDP driving device of this embodiment, a first operation method for invariably simultaneously switching the ON states and the OFF states of the first gate G1 and the second gate G2 of the separation switch QS3, and a second operation method for performing a reverse blocking operation while only one of the first gate G1 and the second gate G2 is caused to be in the ON state as required, are considered.

2.2 First Operation

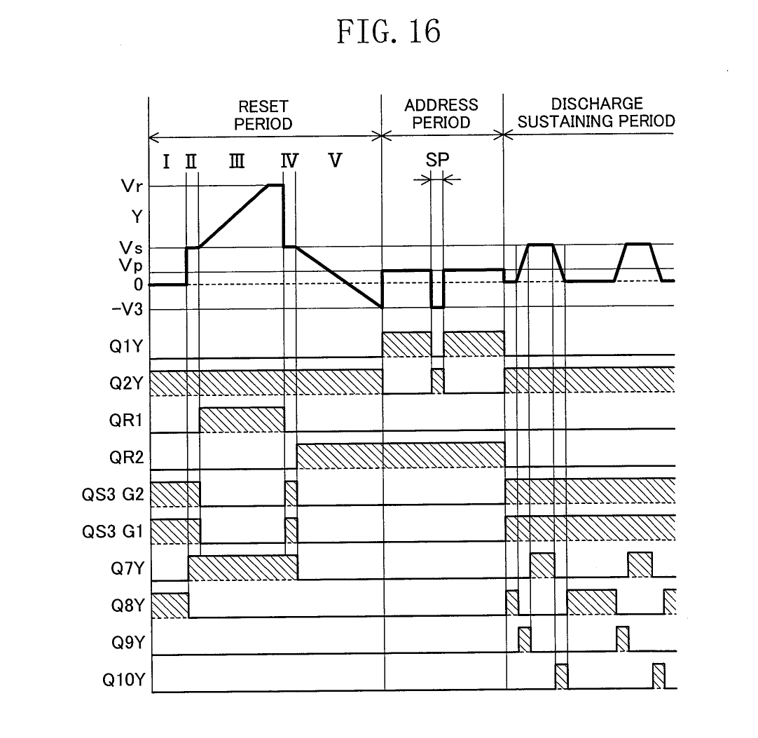

FIG. 16 shows a first operation of the scan electrode driving unit 71 of this embodiment. In FIG. 16, a hatched portion indicates a case where each switch is in the ON state. Also, in this operation, the separation switch QS3 causes both the first gate G1 and the second gate G2 to be in the ON state, so that a current flows in both directions, and causes both the first gate G1 and the second gate G2 to be in the OFF state, so that a current is blocked from flowing in both directions.

2.2.1 Reset Period

The reset period is divided into modes I to V, depending on a change in the reset pulse voltage.

<Mode I>

The low-side scan switch Q2Y, the separation switch QS3 and the low-side sustain switch Q8Y are maintained in the ON state. The other switches are maintained in the OFF state. Thereby, the scan electrode Y is maintained at a ground potential (=0).

<Mode II>

The low-side scan switch Q2Y, the separation switch QS3 and the high-side sustain switch Q7Y are maintained in the ON state. The other switches are maintained in the OFF state. Thereby, the potential of the scan electrode Y increases to a potential that is higher by the voltage Vs of the sustain voltage source Vs than the ground potential.

<Mode III>

While the low-side scan switch Q2Y and the high-side sustain switch Q7Y are maintained in the ON state, the separation switch QS3 is caused to go to the OFF state, and the high-side ramp waveform generating unit QR1 is caused to go to the ON state. The other switches are maintained in the OFF state. Thereby, the potential of the scan electrode Y increases at a constant rate to a potential Vr that is higher by the sum of the voltage Vs of the sustain voltage source Vs and the voltage V2 of the second constant voltage source V2 than the ground potential.

Thereby, voltages applied to all the discharge cells of the PDP 60 uniformly increase relatively gradually to the upper limit reset pulse voltage Vr. As a result, all the discharge cells of the PDP 60 accumulate uniform wall charge. In this case, the rate of an increase in the applied voltages is small, so that the light emission of the discharge cells is suppressed to a small level.

<Mode IV>

While the low-side scan switch Q2Y and the high-side sustain switch Q7Y are maintained in the ON state, the high-side ramp waveform generating unit QR1 is caused to go to the OFF state, and the separation switch QS3 is caused to go to the ON state. The other switches are maintained in the OFF state. Thereby, the potential of the scan electrode Y decreases to a potential that is higher by the voltage Vs of the sustain voltage source Vs than the ground potential.

<Mode V>

While the low-side scan switch Q2Y is maintained in the ON state, the separation switch QS3 and the high-side sustain switch Q7Y are caused to go to the OFF state, and the low-side ramp waveform generating unit QR2 is caused to go to the ON state. The other switches are maintained in the OFF state. The potential of the scan electrode Y decreases at a constant rate to a potential −V3 that is lower by the voltage V3 of the third constant voltage source V3 than the ground potential. Therefore, voltages having a polarity reverse to that of voltages applied in modes II to IV are applied to the discharge cells of the PDP 60. Particularly, the applied voltages relatively gradually decrease. Thereby, wall charge is uniformly removed in all the discharge cells, which become uniform. In this case, the rate of a decrease in the applied voltages is small, so that the light emission of the discharge cells is suppressed to a small level.

2.2.2 Address Period

The operation of this embodiment during the address period is similar to that which has been described in Embodiment 1.

Also, during the address period, the separation switch QS3 is assumed to be invariably in the OFF state.

2.2.3 Discharge Sustaining Period

During the discharge sustaining period, the separation switch QS3 and the low-side scan switch Q2Y are invariably maintained ON. The operations of the other switching devices during the discharge sustaining period are the same as those of the first embodiment.

2.3 Second Operation

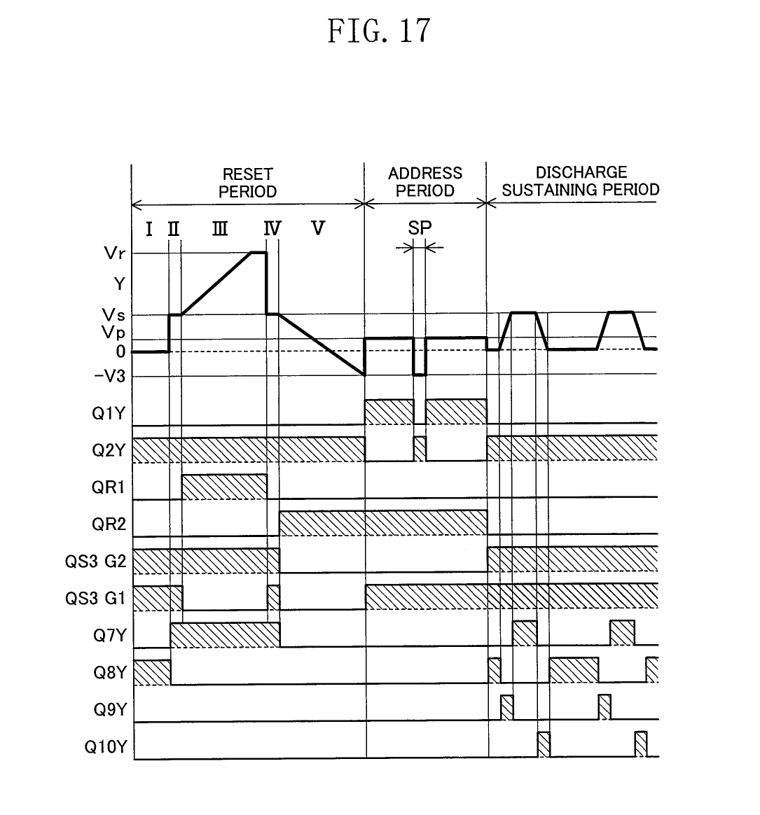

FIG. 17 shows a second operation of the scan electrode driving unit 71 of this embodiment. In FIG. 17, a hatched portion indicates a case where each switch is in the ON state. Hereinafter, an operation during each period will be described, paying attention to operations of the first gate G1 and the second gate G2 of the separation switch QS3.

As shown in FIG. 17, a period during which each switch including the first gate G1 and the second gate G2 of the separation switch QS3 in the second operation is in the ON state is the same as the period in the first operation of FIG. 16. Note that the separation switch QS3 needs to block at least a current from flowing from the drain to the source during mode III of the reset period, and therefore, the first gate G1 of the separation switch QS3 is caused to go to the OFF state, and the second gate G2 is caused to go to the ON state, so that a current is blocked from flowing from the drain to the source of the separation switch QS3. Also, since the separation switch QS3 needs to block a current from flowing from the source to the drain during the address period, the first gate G1 of the separation switch QS3 is caused to go to the ON state, and the second gate G2 is caused to go to the OFF state, so that a current is blocked from flowing from the source to the drain. As described above, the second operation is different from the first operation in that there is a period during which the first gate G1 and the second gate G2 of the separation switch QS3 are in the ON state in addition to a period during which the first gate G1 and the second gate G2 of the separation switch QS3 are in the ON state in the first operation. Specifically, the second operation is different from the first operation in the period during which the first gate G1 and the second gate G2 of the separation switch QS3 are in the ON state.

By performing an operation as described above, even when the aforementioned dual-gate semiconductor device is applied to QS3, the PDP driving device can perform an operation.

2.4 Summary

As shown in FIG. 15, in the scan electrode driving unit 71 of this embodiment, the separation switch QS3 including a dual-gate semiconductor device is provided in a path from the output node (a connection point between the high-side sustain switch Q7Y and the low-side sustain switch Q8Y) J3Y of the discharge sustaining pulse generating unit 3Y to the source of the low-side scan switch Q2Y. Thereby, the potential of the output node J3Y of the discharge sustaining pulse generating unit 3Y changes from Vs to 0. On the other hand, when the separation switch QS3 is not provided, the potential of the output node J3Y changes from the upper limit reset pulse voltage (Vs+V2) to the ground potential to the lower limit reset pulse voltage −V3. Thus, the scan electrode driving unit 71 of this embodiment can have a narrower change range of the potential of the output node J3Y of the discharge sustaining pulse generating unit 3Y than that of the conventional art. In other words, according to this embodiment, each switch device of the discharge sustaining pulse generating unit 3Y can include a low breakdown voltage part. In general, a relationship between the breakdown voltage and the resistance value per unit area is that the resistance value increases with an increase in the breakdown voltage, i.e., the amount of a flowing current significantly decreases. Therefore, in this embodiment, the number of switch devices connected in parallel in the discharge sustaining pulse generating unit 3Y can be reduced, and the device area can be reduced, as compared to the conventional art. In particular, a large current flows through the switches Q7Y, Q8Y, Q9Y and Q10Y of the discharge sustaining pulse generating unit. Therefore, if the resistance value of each switch device can be reduced, the number of switch devices connected in parallel can be reduced. Therefore, the present invention is significantly advantageous. Also, the device area is reduced, so that the wiring impedance of the substrate is reduced. Therefore, ringing that is a high-frequency component generated during application of a voltage to a PDP can be reduced, and therefore, the operation margin of the PDP is increased.

### Third Embodiment

Hereinafter, a PDP driving device according to a third embodiment of the present invention will be described with reference to the drawings.

3.1 Scan Electrode Driving Unit

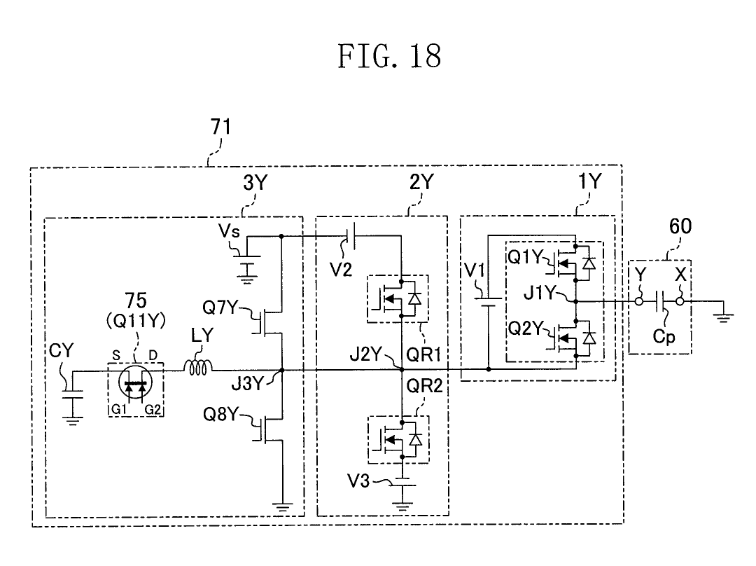

FIG. 18 shows a scan electrode driving unit 71 of the PDP driving device of the third embodiment. In FIG. 18, the same parts as those of FIG. 2 are indicated by the same reference symbols and will not be described.

As shown in FIG. 18, in the scan electrode driving unit 71 of this embodiment, a recovery switch circuit 75 of a discharge sustaining pulse generating unit 3Y includes a recovery switch Q11Y including a dual-gate semiconductor device that performs a bidirectional switch operation. The recovery switch Q11Y of this embodiment may include any of the dual-gate semiconductor devices shown in the first embodiment.

Also, in the conventional recovery switch circuit 75, the bidirectional switch includes at least two MOSFETs and two diodes. In contrast, by replacing the recovery switch circuit 75 with a dual-gate semiconductor device, the recovery switch circuit 75 can be constructed using a single device, so that the number of parts can be reduced, i.e., the circuit scale can be reduced. Also, when a bidirectional switch includes a conventional semiconductor device made of silicon (Si), it is difficult to reduce the on-state resistance due to limitation of the material Si. Therefore, in order to overcome the limitation of the material to reduce conduction loss, a bidirectional switch is used that is made of a wide-gap semiconductor, such as a nitride semiconductor (a representative example: GaN), silicon carbide (SiC) or the like, thereby making it possible to further reduce the conduction loss, and reduce the power loss of the scan electrode driving unit.

The drain of a recovery switch Q11Y is connected to an end of a recovery inductor LY, and the source is connected to an end of an energy-recovery capacitor CY. The other end of the recovery inductor LY is connected to an output node J3Y at which a high-side sustain switch Q7Y is connected to a low-side sustain switch Q8Y, and the other end of the energy-recovery capacitor CY is grounded.

The capacitance of the energy-recovery capacitor CY is sufficiently larger than the panel capacitance Cp of the PDP 60. A voltage between both ends of the energy-recovery capacitor CY is maintained at a value that is substantially equal to the half value Vs/2 of a direct-current voltage Vs applied from the power supply unit.

Note that, in the configuration of FIG. 18, the high-side sustain switch Q7Y and the low-side sustain switch Q8Y each include the bidirectional switch device of the first embodiment, and have the same operations as those that have been described in “1.2 Operation” of the first embodiment.

Also, when the high-side sustain switch Q7Y and the low-side sustain switch Q8Y do not include a bidirectional switch device, it is necessary to connect a high-side separation switch QS1 and a low-side separation switch QS2 to the high-side sustain switch Q7Y and the low-side sustain switch Q8Y, respectively, as in the conventional example of FIG. 27. Also, a separation switch device may be provided between the positive terminal or negative terminal of the sustain voltage source Vs and the scan electrode.

Also, the recovery switch circuit 75 may be applied to other parts in addition to the scan electrode (the scan electrode driving unit 71), i.e., a sustain electrode (sustain electrode driving unit 72) and an address electrode (address electrode driving unit 73).

3.2 First Operation

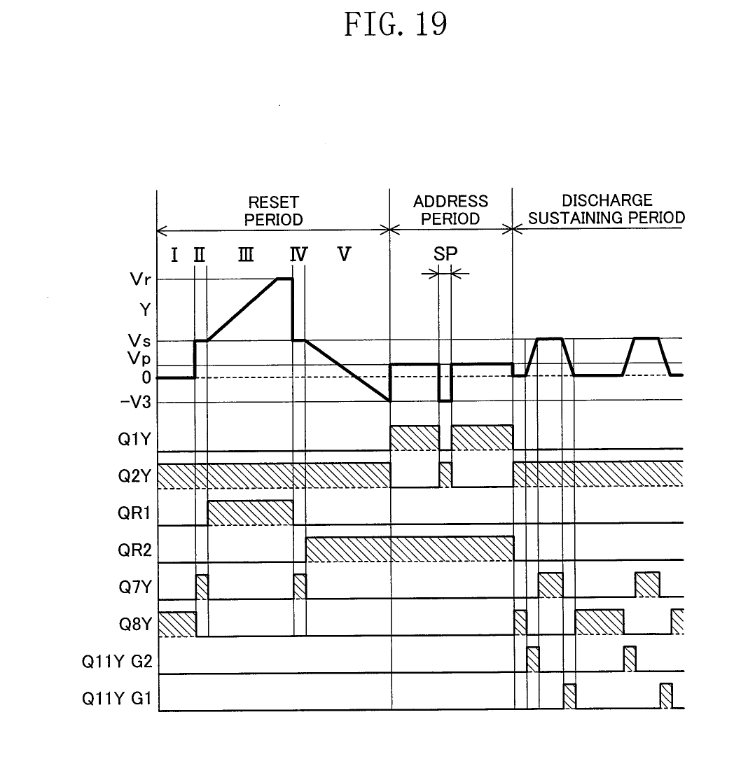

FIG. 19 shows a first operation of the scan electrode driving unit 71 of the PDP driving device of this embodiment.

3.2.1 Reset Period, Address Period The operations of each switch of the scan electrode driving unit 71 during the reset period and the address period are similar to those of the first embodiment described with reference to FIG. 3. Note that this embodiment is different from the first embodiment in that the recovery switch circuit 75 includes only the recovery switch Q11Y having a dual-gate semiconductor device.

The recovery switch Q11Y does not pass a current in both directions during the reset period or the address period. Therefore, during the reset period and the address period, the first gate G1 and the second gate G2 of the recovery switch Q11Y are caused to be in the OFF state, thereby blocking a current from flowing in both directions.

3.2.2 Discharge Sustaining Period

Operations during the discharge sustaining period will be described with reference to FIG. 19.

During the discharge sustaining period, the low-side scan switch Q2Y is invariably maintained in the ON state.

Immediately before the recovery switch Q11Y is caused to go to the ON state, the low-side sustain switch Q8Y is caused to go to the ON state, and a voltage between both ends of the panel capacitance Cp is maintained at 0 V. When the recovery switch Q11Y is caused to go to the ON state, an LC resonance circuit is formed by the energy-recovery capacitor CY, the recovery switch Q11Y, the recovery inductor LY and the panel capacitance Cp, and the voltage between both ends of the panel capacitance Cp increases to Vs (the other switch devices are maintained in the OFF state). In this case, in the recovery switch Q11Y, the first gate G1 is caused to go to the OFF state, and the second gate G2 is caused to go to the ON state, so that a current flows from the source to the drain, and a current does not flow from the drain to the source (reverse blocking operation).

Next, the high-side sustain switch Q7Y is caused to go to the ON state, so that the voltage between both ends of the panel capacitance Cp is maintained at the sustain voltage Vs. In this switching operation, the recovery switch Q11Y performs a reverse blocking operation that blocks a current from flowing from the drain to the source. Therefore, a current does not flow from the sustain voltage source Vs to the energy-recovery capacitor CY. Thereafter, the second gate G2 of the recovery switch Q11Y is caused to go to the OFF state. Note that, at the same time when the high-side sustain switch Q7Y is caused to go to the ON state, the second gate G2 of the recovery switch Q11Y may be caused to go to the OFF state.

Also, in this case, the drain-source voltage of the high-side sustain switch Q7Y is 0. Therefore, the high-side sustain switch Q7Y can be caused to go to the ON state with substantially no loss (the other switch devices are maintained in the OFF state).

After a predetermined time passes, when the high-side sustain switch Q7Y is caused to go to the OFF state, and the recovery switch Q11Y is caused to go to the ON state, an LC resonance circuit is formed by the energy-recovery capacitor CY, the recovery switch Q11Y, the recovery inductor LY and the panel capacitance Cp, so that the voltage between both ends of the panel capacitance Cp decreases to 0 (the other switch devices are maintained in the OFF state). In this case, in the recovery switch Q11Y, the first gate G1 is caused to go to the ON state, and the second gate G2 is caused to go to the OFF state, so that a current flows from the drain to the source, and a current does not flow from the source to the drain (reverse blocking operation).

Next, the low-side sustain switch Q8Y is caused to go to the ON state, so that the voltage between both ends of the panel capacitance Cp is maintained at 0. During this switching operation, the recovery switch Q11Y performs a reverse blocking operation that blocks a current from flowing from the source to the drain, so that accumulated electric charges do not flow from the energy-recovery capacitor CY to the ground. Thereafter, the first gate G1 of the recovery switch Q11Y is caused to go to the OFF state. However, at the same time when the low-side sustain switch Q8Y is caused to go to the ON state, the first gate G1 of the recovery switch Q11Y may be caused to go to the OFF state.

Also, in this case, the drain-source voltage of the low-side sustain switch Q8Y is 0. Therefore, the low-side sustain switch Q8Y can be caused to go to the ON state with substantially no loss (the other switch devices are maintained in the OFF state).

As described above, when the potential of the scan electrode Y increases and decreases, power can be efficiently exchanged between the energy-recovery capacitor CY and the panel capacitance Cp. Therefore, when the discharge sustaining pulse voltage is applied, useless power due to charge and discharge of the panel capacitance can be reduced.

At the moment that the high-side sustain switch Q7Y goes to the ON state in the scan electrode driving unit 71 of FIG. 18, a current tries to flow from the sustain voltage source Vs to the energy-recovery capacitor CY. Therefore, if the recovery switch includes a typical semiconductor switch, it is necessary to perfectly synchronize the timing of switching the recovery switch to the OFF state with the timing of switching the high-side sustain switch Q7Y to the ON state. Actually, however, such an operation is not possible, and therefore, it is necessary to insert a diode so as to block a current from flowing from the sustain voltage source Vs to the energy-recovery capacitor CY. The inserted diode has an on-state resistance, which leads to an increase in power consumption.

On the other hand, in the PDP driving device of this embodiment, the recovery switch Q11Y performs a reverse blocking operation that blocks a current from flowing from the drain D to the source S. Therefore, even if a diode is not inserted, a current does not flow from the sustain voltage source Vs to the energy-recovery capacitor CY. Therefore, it is possible to prevent an increase in power consumption due to the diode. Moreover, in the PDP driving device of this embodiment, a problem does not arise even if the timing of causing the second gate of the recovery switch Q11Y to go to the OFF state is shifted after the timing of causing the high-side sustain switch Q7Y to go to the ON state.

Similarly, in order to prevent a current accumulated in the energy-recovery capacitor CY to flow to the ground, it is necessary to cause the recovery switch circuit 75 to go to the OFF state in perfect synchronization with the transition of the low-side sustain switch Q8Y to the ON state, or insert a diode. In contrast, in the PDP driving device of this embodiment, the recovery switch Q11Y performs a reverse blocking operation that blocks a current from flowing the source S to the drain D. Therefore, in the PDP driving device of this embodiment, it is possible to prevent an increase in power consumption due to the diode, and a problem does not arise even if the timing of causing the first gate of the recovery switch Q11Y to go to the OFF state is shifted after the timing of causing the low-side sustain switch Q8Y to go to the ON state.

3.3 Second Operation

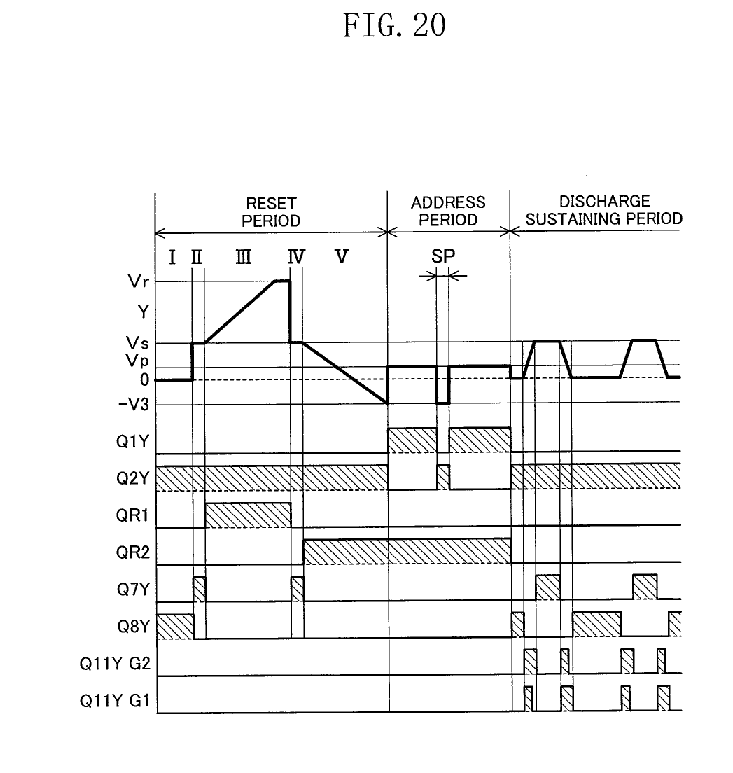

FIG. 20 shows a second operation of the PDP driving device of the third embodiment. In the second operation method, when the recovery switch Q11Y is caused to go to the ON state during the discharge sustaining period, both the first gate G1 and the second gate G2 of the recovery switch Q11Y are caused to go to the ON state. Thereby, the ON voltage occurring when the recovery switch Q11Y performs a reverse blocking operation can be caused to be 0 V, so that the conduction loss of the recovery switch circuit 75 can be further reduced.

3.3.1 Reset Period, Address Period

The operations of each switch in the scan electrode driving unit 71 during the reset period and the address period are the same as the first operation described with reference to FIG. 19.

3.3.2 Discharge Sustaining Period

An operation during the discharge sustaining period will be described with reference to FIG. 20.

During the discharge sustaining period, the low-side scan switch Q2Y is invariably maintained in the ON state.

Immediately before the recovery switch Q11Y is caused to go to the ON state, the low-side sustain switch Q8Y is caused to go to the ON, and a voltage between both ends of the panel capacitance Cp is maintained at 0 V. When the recovery switch Q11Y is caused to go to the ON state, an LC resonance circuit is formed by the energy-recovery capacitor CY, the recovery switch Q11Y, the recovery inductor LY and the panel capacitance Cp, so that the voltage between both ends of the panel capacitance Cp increases to Vs (the other switch devices are maintained in the OFF state). In this case, in the recovery switch Q11Y, the first gate G1 and the second gate G2 are caused to go to the ON state, so that a current flows in both directions between the drain and the source (bidirectional conduction operation). By such an operation, it is possible to cause the ON voltage that would otherwise occur during the reverse blocking operation to be 0 V, thereby reducing the conduction loss of the recovery switch Q11Y.

Next, immediately before the high-side sustain switch Q7Y is caused to go to the ON state, the first gate G1 of the recovery switch Q11Y is caused to go to the OFF state, so that a current flows from the source to the drain of the recovery switch Q11Y, and a current is blocked from flowing from the drain to the source (reverse blocking operation).

Thereafter, if the high-side sustain switch Q7Y is caused to go to the ON, the voltage between both ends of the panel capacitance Cp is maintained at Vs. During this switching operation, the recovery switch Q11Y performs a reverse blocking operation that blocks a current from flowing from the drain to the source, so that a current does not flow from the sustain voltage source Vs to the energy-recovery capacitor CY. Thereafter, the second gate G2 of the recovery switch Q11Y is caused to go to the OFF state. Alternatively, at the same time when the high-side sustain switch Q7Y is caused to go to the ON state, the second gate G2 of the recovery switch Q11Y may be caused to go to the OFF state.

Also, in this case, the drain-source voltage of the high-side sustain switch Q7Y is 0. Therefore, the high-side sustain switch Q7Y can be caused to go to the ON state with substantially no loss (the other switch devices are maintained in the OFF state).

After a predetermined time passes, when the high-side sustain switch Q7Y is caused to go to the OFF state and the recovery switch Q11Y is caused to go to the ON state, an LC resonance circuit is formed by the energy-recovery capacitor CY, the recovery switch Q11Y, the recovery inductor LY and the panel capacitance Cp, so that the voltage between both ends of the panel capacitance Cp decreases to 0 (the other switch devices are maintained in the OFF state). In this case, in the recovery switch Q11Y, the first gate G1 and the second gate G2 are caused to go to the ON state, so that a current flows in both directions between the drain and the source (bidirectional conduction operation). By such an operation, it is possible to cause the ON voltage that would otherwise occur during the reverse blocking operation to be 0 V, and reduce the conduction loss of the recovery switch Q11Y.

Next, immediately before the low-side sustain switch Q8Y is caused to go to the ON state, the second gate G2 of the recovery switch Q11Y is caused to go to the OFF state, so that a current flows from the drain to the source of the recovery switch Q11Y, and a current is blocked from flowing from the source to the drain (reverse blocking operation).

Thereafter, if the low-side sustain switch Q8Y is caused to go to the ON, the voltage between both ends of the panel capacitance Cp is maintained at 0. During this switching operation, the recovery switch Q11Y performs a reverse blocking operation that blocks a current from flowing from the source to the drain, so that a current does not flow from the energy-recovery capacitor CY to the ground via the low-side sustain switch Q8Y. Thereafter, the first gate G1 of the recovery switch Q11Y is caused to go to the OFF state. Alternatively, at the same time when the low-side sustain switch Q8Y is caused to go to the ON state, the first gate G1 of the recovery switch Q11Y may be caused to go to the OFF state.

Also, in this case, the drain-source voltage of the low-side sustain switch Q8Y is 0. Therefore, the low-side sustain switch Q8Y can be caused to go to the ON state with substantially no loss (the other switch devices are maintained in the OFF state).

When the potential of the scan electrode Y increases and decreases, power can be efficiently exchanged between the energy-recovery capacitor CY and the panel capacitance Cp. Therefore, when the discharge sustaining pulse voltage is applied, useless power due to charge and discharge of the panel capacitance Cp can be reduced.

3.4 Summary

As shown in FIG. 18, in the PDP driving device of this embodiment, the recovery switch circuit 75 includes only the recovery switch Q11Y, which is a dual-gate semiconductor device. In other words, only the recovery switch Q11Y exists in the path from the energy-recovery capacitor CY via the inductor LY to the source of the low-side scan switch Q2Y. Thus, the first recovery diode D1 and the second recovery diode D2 can be removed from the PDP driving device 62 of this embodiment, as is different from conventional devices. Therefore, in the PDP driving device 62 of this embodiment, the number of parts and the device area can be reduced as compared to conventional devices.

Particularly, since a large current flows through the first recovery diode D1 and the second recovery diode D2, a large number of diodes are typically connected in parallel. Therefore, a significant advantage is obtained if the first recovery diode D1 and the second recovery diode D2 are removed. Also, conduction loss during the discharge sustaining period due to the first recovery diode D1 and the second recovery diode D2 is significantly reduced, resulting in a reduction in power consumption.

Also, when a current is caused to flow through the recovery switch Q11Y, then if the bidirectional switch operation that causes a current to flow in both directions and the reverse blocking operation are combined, the ON voltage that occurs during the reverse blocking operation can be reduced, thereby reducing conduction loss.

Note that, in the PDP driving device of this embodiment, a drive circuit for driving the first gate G1 and the second gate G2 of the recovery switch Q11Y may be the same as that of the first embodiment.

The high-side sustain switch Q7Y and the low-side sustain switch Q8Y may each include a dual-gate semiconductor device as in the first embodiment. Also, a bidirectional switch including a combination of a plurality of transistors and diodes may be used. Moreover, a sustain switch device and a separation switch device may be combined.

Also, the recovery switch circuit 75 and its drive method of this embodiment are applicable not only to the scan electrode driving unit 71, but also to the sustain electrode driving unit 72 and the address electrode driving unit 73.

### Fourth Embodiment

Hereinafter, a PDP driving device according to a fourth embodiment of the present invention will be described with reference to the drawings.

4.1 Scan Electrode Driving Unit

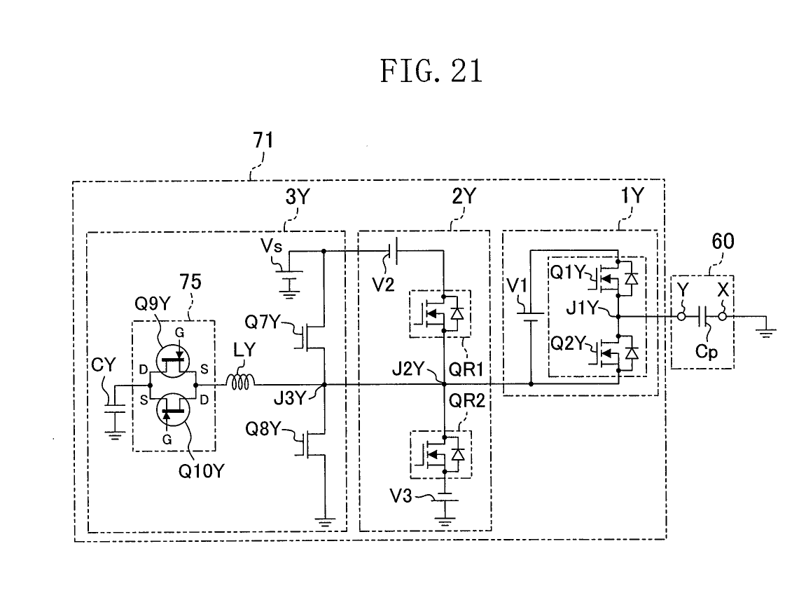

FIG. 21 shows a scan electrode driving unit 71 of the PDP driving device of the fourth embodiment. In FIG. 21, the same parts as those of FIG. 2 are indicated by the same reference symbols and will not be described.

As shown in FIG. 21, in the scan electrode driving unit 71 of this embodiment, a recovery switch circuit 75 of a discharge sustaining pulse generating unit 3Y includes a high-side recovery switch Q9Y and a low-side recovery switch Q10Y each of which includes a switch device including a dual-gate semiconductor device.

The high-side recovery switch Q9Y and the low-side recovery switch Q10Y of this embodiment can include any of the dual-gate semiconductor devices shown in the first embodiment. In this embodiment, the second gate electrode and the drain electrode of the dual-gate semiconductor device are short-circuited, and the resultant dual-gate semiconductor device is used as a reverse blocking switch for performing a reverse blocking operation.

In the conventional recovery switch circuit 75, the bidirectional switch includes at least two MOSFETs and two diodes. By replacing the recovery switch circuit 75 with two dual-gate semiconductor devices, the recovery switch circuit 75 can be constructed using two devices, so that the number of parts can be reduced, i.e., the circuit scale can be reduced.

The source of the high-side recovery switch Q9Y and the drain of the low-side recovery switch Q10Y are connected to an end of the recovery inductor LY, and the drain of the high-side recovery switch Q9Y and the source of the low-side recovery switch Q10Y are connected to an end of the energy-recovery capacitor CY. The other end of the recovery inductor LY is connected to an output node J3Y at which the high-side sustain switch Q7Y and the low-side sustain switch Q8Y are connected, and the other end of the energy-recovery capacitor CY is grounded.

The capacitance of the energy-recovery capacitor CY is sufficiently larger than the panel capacitance Cp of the PDP 60. A voltage between both ends of the energy-recovery capacitor CY is maintained at a value that is substantially equal to the half value Vs/2 of a direct-current voltage Vs applied from the power supply unit.

Note that, in the configuration of FIG. 21, the high-side sustain switch Q7Y and the low-side sustain switch Q8Y may not include a dual-gate semiconductor device. In this case, a high-side separation switch QS1 and a low-side separation switch QS2 need to be connected to the high-side sustain switch Q7Y and the low-side sustain switch Q8Y, respectively. Also, as in the second embodiment, a separation switch device may be provided between the positive terminal or the negative terminal of the sustain voltage source Vs, and the scan electrode Y.

Also, the recovery switch circuit 75 is applicable to electrodes other than the scan electrode (the scan electrode driving unit 71), i.e., the sustain electrode (the sustain electrode driving unit 72) and the address electrode (the address electrode driving unit 73).

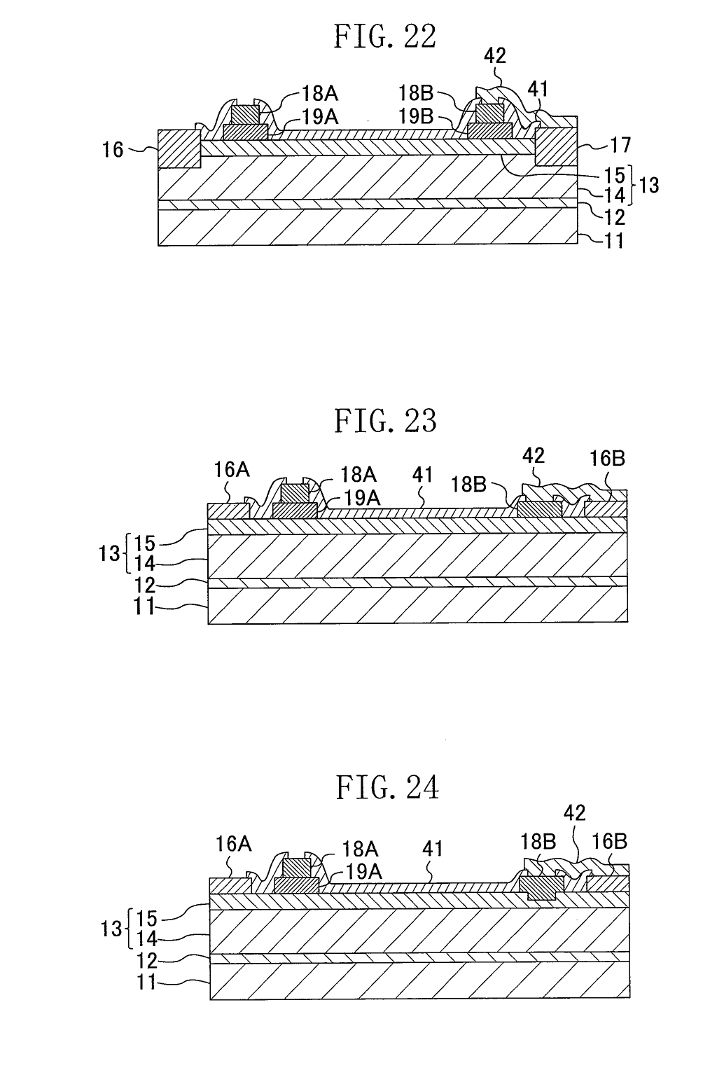

When a dual-gate semiconductor device is used as the high-side recovery switch Q9Y and the low-side recovery switch Q10Y of this embodiment, the second gate electrode and the drain electrode may be short-circuited. In this case, as shown in FIG. 22, a wiring line 42 for short-circuiting the second gate electrode 18B and the drain electrode 17 may be formed and integrated with the semiconductor device. In this case, the wiring line 42 may be made of Au or the like.

With such a configuration, a so-called 3-terminal transistor whose source electrode is a source, whose drain electrode is a drain, and whose first gate is a gate can be achieved. It is advantageously easy to perform gate drive with respect to the 3-terminal transistor.

In this case, the second gate electrode 18B and the drain electrode 17 are electrically short-circuited, so that a voltage therebetween is 0 V, and therefore, a voltage lower than or equal to the threshold voltage is applied to the second gate electrode 18B. Therefore, in the device shown in FIG. 22, a current can be caused to flow from the drain to the source, and a current is not caused to flow from the source to the drain in the ON state. In the OFF state, a current is not caused to flow in both directions, i.e., from the drain to the source and from the source to the drain. Also, in the OFF state, the absolute maximum rated drain-source voltage and the absolute maximum rated source-drain voltage of the device both have a sufficient value.

Note that not only the first dual-gate semiconductor device of FIG. 5, but also the dual-gate semiconductor devices of FIGS. 9 and 10 can have a similar structure.

Also, as shown in FIG. 23, a first gate electrode 18A and a second gate electrode 18B may have different structures. In FIG. 23, the first gate electrode 18A is formed via a first p-type semiconductor layer 19A on an AlGaN layer 15, and the second gate electrode 18B is formed, contacting the AlGaN layer 15. Thereby, the second gate electrode 18B has a Schottky junction with the AlGaN layer 15.

With such a structure, the threshold voltage of the first gate electrode 18A and the threshold voltage of the second gate electrode 18B can have different values. For example, if the threshold voltage of the first gate electrode is about 1 V, and the threshold voltage of the second gate electrode is about 0 V, an ON voltage due to the threshold voltage of the second gate electrode 18B, i.e., the ON voltage of the diode of FIG. 7(c) can be caused to be substantially 0 V. Thereby, the loss of the switch device can be further reduced, and therefore, the power consumption of the PDP driving device can be reduced.

Note that, in order to cause the threshold voltage of the second gate electrode to be higher than or equal to 0 V, the thickness of the AlGaN layer 15 is preferably set to be thinner (i.e., about 5 nm) than that of the dual-gate semiconductor device of FIG. 5.

Also, as shown in FIG. 24, the second gate electrode 18B may be formed and embedded in a concave portion formed in the AlGaN layer 15. Even with such a structure, an ON voltage due to the threshold voltage of the second gate electrode 18B can be set to be substantially 0. Moreover, a normally-OFF characteristic can be obtained without reducing the thickness of the whole AlGaN layer 15. Therefore, the electron sheet carrier concentration of the channel region can be maintained high, so that the on-state resistance can be further reduced.

Note that the wiring line 42 may be anything that can electrically connect the second gate electrode 18B and the drain electrode 17. The wiring line 42 may be made of a metal, such as aluminum (Al), copper (Cu) or the like, instead of Au.

The high-side sustain switch Q7Y and the low-side sustain switch Q8Y may each include a dual-gate semiconductor device as in the first embodiment. Also, a bidirectional switch including a combination of a plurality of transistors and diodes may be used. Moreover, a sustain switch device and a separation switch device may be combined.

4.2 Operation

In the scan electrode driving unit 71 of this embodiment, the waveforms of voltages applied to the scan electrode Y of the PDP 60 during the reset period, the address period and the discharge sustaining period, and a period during each switch included in the scan electrode driving unit 71 is caused to be in the ON state, are similar to those of the operation of FIG. 3 in the first embodiment.

4.3 Summary

In the fourth embodiment, as shown in FIG. 23, the recovery switch circuit 75 includes the high-side recovery switch Q9Y and the low-side recovery switch Q10Y, each of which is a dual-gate semiconductor device. Specifically, only the recovery switch Q9Y or the recovery switch Q10Y exists in a path from the energy-recovery capacitor CY via the inductor LY to the source of the low-side scan switch Q2Y. Thus, in the PDP driving device 62 of this embodiment, the first recovery diode D1 and the second recovery diode D2 can be removed, as is different from conventional devices. Therefore, in the PDP driving device 62 of this embodiment, the number of parts and the device area can be reduced as compared to conventional devices.

Particularly, since a large current flows through the first recovery diode D1 and the second recovery diode D2, a large number of diodes are typically connected in parallel. Therefore, a significant advantage is obtained if the first recovery diode D1 and the second recovery diode D2 are removed. Also, conduction loss during the discharge sustaining period due to the first recovery diode D1 and the second recovery diode D2 is significantly reduced, resulting in a reduction in power consumption.

The dual-gate semiconductor device having a low ON voltage of FIG. 23 or 24 is used as the high-side recovery switch Q9Y and the low-side recovery switch Q10Y. Therefore, when a current passes, conduction loss that occurs due to the ON voltage can be reduced.

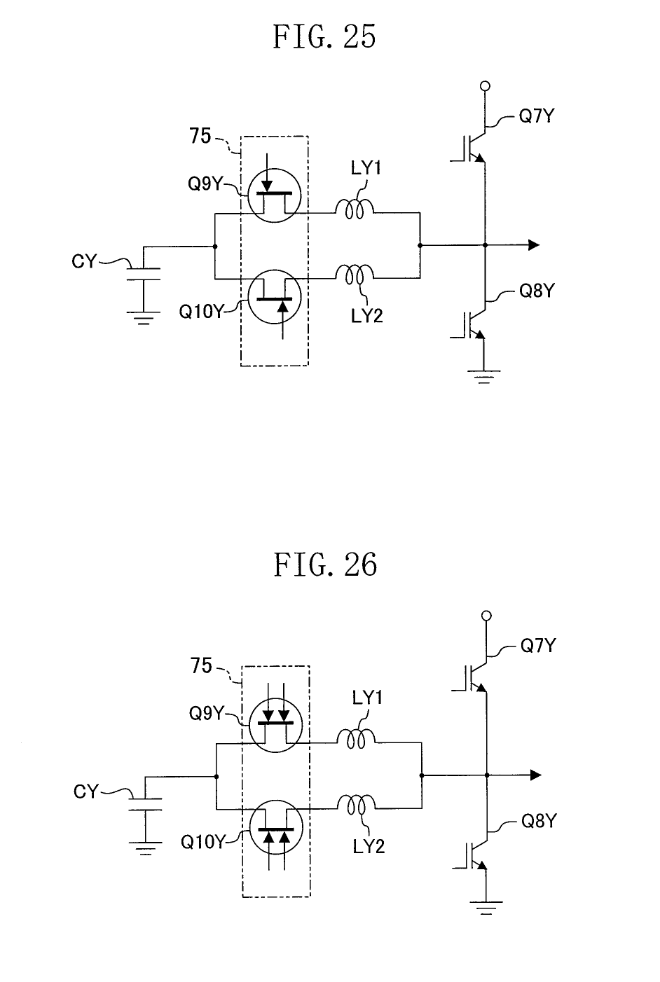

Although FIG. 21 shows an example where a single recovery inductor LY is used, a high-side the recovery inductor LY1 and a low-side the recovery inductor LY2 may be provided as shown in FIG. 25 or 26. In this case, the high-side the recovery inductor LY1 and the low-side the recovery inductor LY2 can have different values, so that an optimal resonance current can be generated when a current flows from the energy-recovery capacitor CY to the panel capacitance Cp and when a current flows from the panel capacitance Cp to the energy-recovery capacitor CY.

Also, as in the first embodiment, by using a wide-band gap semiconductor, such as representatively GaN, SiC or the like, in the dual-gate semiconductor device, conduction loss can be reduced, so that power consumption can be reduced.

Although the scan electrode driving unit of the PDP driving device has been described by way of example in each embodiment, the sustain electrode driving unit and the address electrode driving unit have the same basic configuration as that of the scan electrode driving unit, and therefore, the concept of the present invention is also applicable to the sustain electrode driving unit and the address electrode driving unit.

### INDUSTRIAL APPLICABILITY

The plasma display panel driving device and the plasma display of the present invention can provide a PDP driving device in which the number of parts is small and power consumption is small, and are useful for a plasma display panel driving device, a plasma display and the like.

1. A plasma display panel driving device comprising:
an electrode driving unit for generating a drive pulse to be applied to an electrode of a plasma display panel,
wherein the electrode driving unit has a plurality of switches,
at least one of the plurality of switches is a switch device including a dual-gate semiconductor device, and
the dual-gate semiconductor device has:
a semiconductor multilayer formed on a substrate and made of a nitride semiconductor or a silicon carbide semiconductor;
a source electrode and a drain electrode formed and spaced apart from each other on the semiconductor multilayer; and
a first gate electrode and a second gate electrode formed between the source electrode and the drain electrode, successively from the source electrode side.

2. The plasma display panel driving device of claim 1, wherein
the electrode driving unit has a sustain voltage source for generating a voltage for sustaining discharge of the plasma display panel,
the plurality of switches include a high-side sustain switch and a low-side sustain switch connected in series between a positive terminal and a negative terminal of the sustain voltage source, and
at least one of the high-side sustain switch and the low-side sustain switch is a switch device including the dual-gate semiconductor device.

3. The plasma display panel driving device of claim 1, wherein
the electrode driving unit has a sustain voltage source for generating a voltage for sustaining discharge of the plasma display panel,
the plurality of switches include a high-side sustain switch and a low-side sustain switch connected in series between a positive terminal and a negative terminal of the sustain voltage source, and a separation switch connected between a connection node of the high-side sustain switch and the low-side sustain switch, and the electrode of the plasma display panel, and
the separation switch is a switch device including the dual-gate semiconductor device.

4. The plasma display panel driving device of claim 1, wherein
the electrode driving unit has an energy-recovery capacitor for recovering and accumulating electric charges accumulated in the electrode of the plasma display panel,
the plurality of switches include a recovery switch provided between the electrode of the plasma display panel and the energy-recovery capacitor, and
the recovery switch is a switch device including the dual-gate semiconductor device.

5. The plasma display panel driving device of claim 1, wherein
the electrode driving unit has an energy-recovery capacitor for recovering and accumulating electric charges accumulated in the electrode of the plasma display panel,
the plurality of switches include a first recovery switch and a second recovery switch provided between the electrode of the plasma display panel and the energy-recovery capacitor, and
the first recovery switch and the second recovery switch are each a switch device including the dual-gate semiconductor device.

6. The plasma display panel driving device of claim 4, wherein
the recovery switch, when causing a current to flow from the energy-recovery capacitor to the electrode, goes to a first mode in which a current is caused to flow from the energy-recovery capacitor to the electrode and a current is blocked from flowing to the energy-recovery capacitor, and
the recovery switch, when causing a current to flow from the electrode to the energy-recovery capacitor, goes to a second mode in which a current is caused to flow from the electrode to the energy-recovery capacitor and a current is blocked from flowing from the energy-recovery capacitor.

7. The plasma display panel driving device of claim 6, wherein
the recovery switch, when causing a current to flow from the energy-recovery capacitor to the electrode, goes to a third mode in which a voltage higher than or equal to a threshold voltage of the first gate electrode with reference to a potential of the source electrode is applied to the first gate electrode, and a voltage higher than or equal to a threshold voltage of the second gate electrode with reference to a potential of the drain electrode is applied to the second gate electrode, thereby causing a current to flow between the drain electrode and the source electrode, before going to the first mode, and
the recovery switch, when causing a current to flow from the electrode to the energy-recovery capacitor, goes to the third mode before going to the second mode.

8. The plasma display panel driving device of claim 5, wherein
the first recovery switch, when causing a current to flow from the energy-recovery capacitor to the electrode, goes to a first mode in which a current is caused to flow from the energy-recovery capacitor to the electrode and a current is blocked from flowing to the energy-recovery capacitor, and
the second recovery switch, when causing a current to flow from the electrode to the energy-recovery capacitor, goes to a second mode in which a current is caused to flow from the electrode to the energy-recovery capacitor and a current is blocked from flowing from the energy-recovery capacitor.

9. The plasma display panel driving device of claim 8, wherein
the first recovery switch, when causing a current to flow from the energy-recovery capacitor to the electrode, goes to a third mode in which a voltage higher than or equal to a threshold voltage of the first gate electrode with reference to a potential of the source electrode is applied to the first gate electrode, and a voltage higher than or equal to a threshold voltage of the second gate electrode with reference to a potential of the drain electrode is applied to the second gate electrode, thereby causing a current to flow between the drain electrode and the source electrode, before going to the first mode, and
the second recovery switch, when causing a current to flow from the electrode to the energy-recovery capacitor, goes to the third mode before going to the second mode.

10. The plasma display panel driving device of claim 1, wherein
the dual-gate semiconductor device is normally OFF.

11. The plasma display panel driving device of claim 1, wherein
the semiconductor multilayer has a first semiconductor layer, and a first p-type semiconductor layer selectively formed on the first semiconductor layer, and
the first gate electrode is formed on the first p-type semiconductor layer.

12. The plasma display panel driving device of claim 11, wherein
the semiconductor multilayer has a first semiconductor layer, and a second p-type semiconductor layer selectively formed on the first semiconductor layer, and
the second gate electrode is formed on the second p-type semiconductor layer.

13. The plasma display panel driving device of claim 1, further comprising:
an insulating film formed between at least one of the first gate electrode and the second gate electrode, and the semiconductor multilayer.

14. The plasma display panel driving device of claim 1, wherein
the semiconductor multilayer has a concave portion, and
at least one of the first gate electrode and second gate electrode is embedded in the concave portion.

15. The plasma display panel driving device of claim 1, wherein
the threshold voltage of the first gate electrode of the dual-gate semiconductor device is different from the threshold voltage of the second gate electrode.

16. The plasma display panel driving device of claim 1, wherein
the second gate electrode and the drain electrode of the dual-gate semiconductor device are electrically connected.

17. The plasma display panel driving device of claim 1, wherein
a space between the first gate electrode and the second gate electrode of the dual-gate semiconductor device is larger than a space between the source electrode and the first gate electrode and is larger than a space between the drain electrode and the second gate electrode.

18. The plasma display panel driving device of claim 1, wherein
the semiconductor multilayer of the dual-gate semiconductor device has a first semiconductor layer and a second semiconductor layer successively laminated from the substrate side, and
the second semiconductor layer has a band gap larger than that of the first semiconductor layer.

19. The plasma display panel driving device of claim 1, wherein
the semiconductor multilayer includes at least one of gallium nitride and aluminum nitride gallium.

20. A plasma display comprising:
a plasma display panel in which a fluorescent material emits light due to discharge between electrodes; and
the plasma display panel driving device of claim 1.
